(19) United States
(12) Patent Application Publication
(10) Pub. No.: US 2026/0225838 A1
(43) Pub. Date: Aug. 6, 2026

(54) SHEET CONVEYING DEVICE AND IMAGE FORMING APPARATUS

(71) Applicant: Yuka NAKAO, Aichi (JP)

(72) Inventor: Yuka NAKAO, Aichi (JP)

(73) Assignee: ETRIA CO., LTD., Yokohama, Kanagawa (JP)

(21) Appl. No.: 19/425,326

(22) Filed: Dec. 18, 2025

(30) Foreign Application Priority Data
Feb. 6, 2025 (JP) 2025-018523

(51) Int. Cl. B65H 7/06; B65H 7/20; G03G 15/00

(52) U.S. Cl. CPC B65H 7/06; B65H 7/20; G03G 15/70; B65H 2511/528; B65H 2553/30

(57) ABSTRACT

A sheet conveying device including a conveyance path, a conveyor, a sound collector, and circuitry. The conveyor conveys a medium along the conveyance path. The sound collector is disposed in a vicinity of the conveyor to collect a sound occurred in conveyance of the medium along the conveyance path by the conveyor. The circuitry is to determine whether an abnormal condition has occurred during the conveyance of the medium based on the sound collected by the sound collector to perform an abnormality determination process, and skip the abnormality determination process when the sound collected during a given period satisfies a given condition.

### CROSS-REFERENCE TO RELATED APPLICATION

This patent application is based on and claims priority pursuant to 35 U.S.C. § 119(a) to Japanese Patent Application No. 2025-018523, filed on Feb. 6, 2025, in the Japan Patent Office, the entire disclosure of which is hereby incorporated by reference herein.

### BACKGROUND

### Technical Field

Embodiments of the present disclosure relate to a sheet conveying device and an image forming apparatus.

### Related Art

Sheet conveying devices for conveying documents are likely to cause a paper jam while the document is conveyed. For this reason, such sheet conveying devices are provided with a technique for detecting a paper jam when the paper jam occurs.

For example, a sheet conveying device in the art proposes a technique of detecting the presence or absence of occurrence of conveyance abnormality according to whether a sound in a specific frequency band corresponding to the thickness of a sheet is generated.

However, in the typical technique such as the technique of the sheet conveying device in the art, when a sound that is not related to the conveyance abnormality, such as an environmental sound, is generated, a sound in a specific frequency band is often included, which leads to occurrence of an erroneous determination.

### SUMMARY

Embodiments of the present disclosure described herein provide a novel sheet conveying device including a conveyance path, a conveyor, a sound collector, and circuitry. The conveyor conveys a medium along the conveyance path. The sound collector is disposed in a vicinity of the conveyor to collect a sound occurred in conveyance of the medium along the conveyance path by the conveyor. The circuitry is to determine whether an abnormal condition has occurred during the conveyance of the medium based on the sound collected by the sound collector to perform an abnormality determination process, and skip the abnormality determination process when the sound collected during a given period satisfies a given condition.

Further, embodiments of the present disclosure described herein provide an image forming apparatus includes a conveyance path, a conveyor, a sound collector, and circuitry. The conveyor conveys a conveyance medium along the conveyance path. The sound collector is disposed in the conveyor. The circuitry is to determine whether an abnormal condition has occurred in conveyance of the conveyance medium by the conveyor based on a sound collected by the sound collector, and skip a determination as to whether the abnormal condition has occurred in the conveyance of the conveyance medium by the conveyor when the sound collected by the sound collector during a given period satisfies a given condition.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of a multifunction peripheral according to an embodiment;

FIG. 2 is a partial configuration diagram illustrating a configuration of a part of an internal configuration of an image forming apparatus according to an embodiment;

FIG. 3 is an enlarged view illustrating a part of a tandem section according to an embodiment;

FIG. 4 is a perspective view illustrating a scanner and an automatic document feeder (ADF) of the multifunction peripheral according to an embodiment;

FIG. 5 is an enlarged configuration diagram illustrating a main section configuration of the ADF with an upper part of the scanner according to an embodiment;

FIG. 6 is a perspective view exemplifying the ADF according to an embodiment;

FIG. 7 is a block diagram illustrating a part of a configuration of a multifunction peripheral according to a first embodiment;

FIG. 8 is a diagram exemplifying software configurations of a device controller and a controller of ADF according to the first embodiment;

FIG. 9 is a flowchart exemplifying a procedure of a conveyance processing in the multifunction peripheral according to the first embodiment;

FIG. 10 is a flowchart exemplifying a procedure of setting processing of a skip execution flag of conveyance abnormality determination in the device controller of an image forming section and the controller of ADF according to the first embodiment;

FIG. 11 is a diagram exemplifying a conveyance abnormality determination skip setting screen displayed by a display control unit according to the first embodiment;

FIG. 12 is a diagram illustrating an example of a screen displayed by the display control unit of the device controller according to the first embodiment;

FIG. 13 is a flowchart exemplifying a procedure of a conveyance processing in a multifunction peripheral according to a modification of the first embodiment;

FIG. 14 is a flowchart exemplifying a procedure of setting processing of a skip execution flag of conveyance abnormality determination in the device controller of the image forming section and the controller of the ADF according to the second embodiment;

FIG. 15 is a diagram exemplifying a software configuration of a multifunction peripheral according to a third embodiment;

FIG. 16 is a flowchart exemplifying a procedure of setting processing of a skip execution flag of conveyance abnormality determination in the device controller of the image forming section and the controller of the ADF according to the third embodiment;

FIG. 17 is a block diagram illustrating a part of an electric circuit of a multifunction peripheral and a server according to a fourth embodiment; and

FIG. 18 is a partial configuration diagram illustrating a part of a periphery of a manual sheet feeding device of a multifunction peripheral according to a fifth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

Hereinafter, an embodiment of a sheet conveying device and an image forming apparatus according to the present invention will be described in detail with reference to the drawings.

### First Embodiment

The multifunction peripheral according to the present embodiment may use, for example, a multifunction full-color digital (Multifunction Peripheral/Product/Printer, MFP) as an example of an image forming apparatus that forms a color image by an electrophotography method.

An embodiment using a multifunction peripheral of an electrophotography method (simply referred to as multifunction peripheral) will be described. First, a description is now given of the basic configuration of a multifunction peripheral according to the present embodiment.

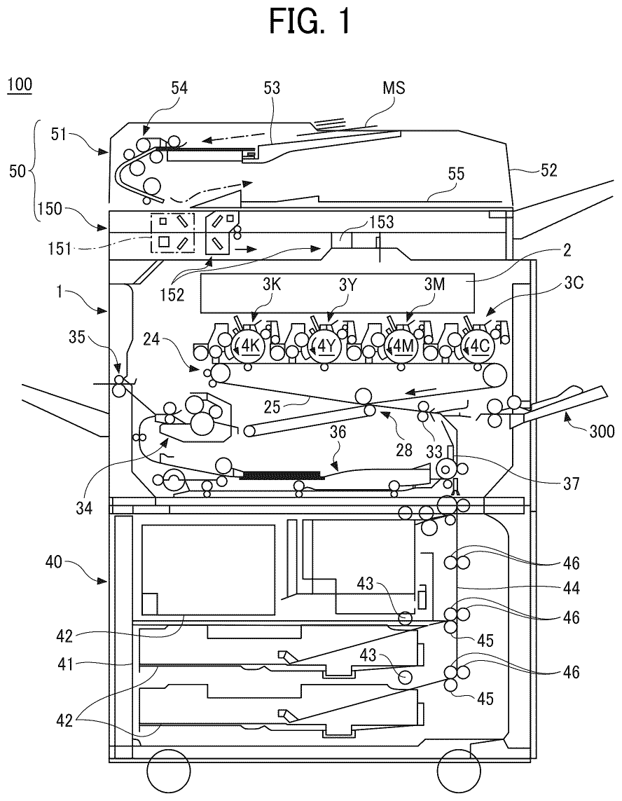

FIG. 1 is a schematic diagram of a multifunction peripheral according to an embodiment.

In the example of FIG. 1, a multifunction peripheral 100 includes an image forming device 1, a sheet supply device 40, an image reading system 50, and a manual sheet feeding device 300. The image reading system 50 includes a scanner 150 as an image reader that is secured on the image forming device 1, and an automatic document feeder (referred to as an ADF) 51 supported by the scanner 150. In the present embodiment, a case where an ADF 51 conveys a document MS which is an example of a conveyance medium will be described.

A sheet supply device 40 includes two sheet feeding cassettes 42 disposed in multiple stages in a paper bank 41, and a sheet feeding roller 43 that sends out a recording sheet from the sheet feeding cassettes 42. The sheet supply device 40 further includes a sheet separation roller 45 that separates the fed recording sheets one by one. In addition, the sheet supply device 40 includes multiple conveyance roller pairs 46 each of which conveys the recording sheet in a sheet conveyance path 37 as a conveyance path in the image forming device 1.

The sheet feeding cassette 42 accommodates recording sheets inside in a bundle of multiple recording sheets. The sheet feeding roller 43 press-contacts the uppermost sheet of the bundle of the sheets. As the sheet feeding roller 43 rotates, the uppermost sheet of the multiple recording sheets is fed from the selected one of the sheet feeding cassettes 42.

A first conveyance roller and a second conveyance roller adjacent to (on the right side of FIG. 1 of) the first conveyance roller of the conveyance roller pair 46 are disposed near the sheet feeding cassette 42 and are in contact with each other to form a conveyance nip region.

A sheet separation roller 45 is disposed below the first conveyance roller and is in contact with the first conveyance roller from below to form a separation conveyance nip region.

A recording sheet fed from one of the sheet feeding cassettes 42 driven and rotated by a corresponding one of the sheet feeding rollers 43 enters the separation conveyance nip region formed by the contact of the first conveyance roller of the conveyance roller pair 46 and a sheet separation roller 45 disposed below the first conveyance roller. In the separation conveyance nip region, the first conveyance roller that contacts the upper face of the recording sheet applies a conveyance force to the recording sheet from the sheet feeding cassette 42 toward a sheet feeding path 44 as the first conveyance roller is driven and rotated in the counterclockwise direction in FIG. 1. In contrast, the sheet separation roller 45 that is in contact with the lower face of the recording sheet applies a conveyance force to the recording sheet from the sheet feeding path 44 toward the sheet feeding cassette 42 as the sheet separation roller 45 is driven and rotated in the counterclockwise direction in FIG. 1, thereby returning the recording sheet to the sheet feeding cassette 42.

When only one recording sheet is fed from the sheet feeding cassette 42, the first conveyance roller of the conveyance roller pair 46 and the sheet separation roller 45 apply the conveyance force to the recording sheet toward opposite directions to each other in the separation conveyance nip region. As a result, a load exceeding a given threshold value is applied to the drive transmission system of the sheet separation roller 45. Then, a torque limiter disposed in the drive transmission system of the sheet separation roller 45 is operated to cut off the transmission of the driving force from a direct current (DC) brushless motor to the sheet separation roller 45. Accordingly, the sheet separation roller 45 is rotated with the recording sheet that is conveyed by the first conveyance roller, and the recording sheet is then ejected from the separation conveyance nip region to the sheet feeding path 44.

On the other hand, when the multiple recording sheets are fed from the sheet feeding cassette 42 with the multiple recording sheets overlapped to each other, the first conveyance roller applies the conveyance force to the uppermost sheet of the multiple recording sheets from the sheet feeding cassette 42 toward the sheet feeding path 44 in the separation conveyance nip region. The uppermost sheet of the recording sheets is fed from the separation conveyance nip region toward the sheet feeding path 44. On the other hand, the sheet separation roller 45 applies the conveyance force from the sheet feeding path 44 toward the sheet feeding cassette 42 to the lower recording sheet or sheets of the multiple recording sheets, so that the lower recording sheet is (or sheets are) reversed from the separation conveyance nip region toward the sheet feeding cassette 42. Accordingly, in the separation conveyance nip region, the uppermost recording sheet is separated from other recording sheet or sheets so as to be conveyed alone to the sheet feeding path 44.

The recording sheet on the sheet feeding path 44 enters the conveyance nip region of the conveyance roller pair 46 where the conveyance force is applied upward from below in the vertical direction. Accordingly, the recording sheet in the sheet feeding path 44 is conveyed toward the sheet conveyance path 37 of the image forming device 1.

The image forming device 1 includes an optical writing device 2, and four image formation units 3K, 3Y, 3M and 3C. The image formation units 3K, 3Y, 3M and 3C form black, yellow, magenta, and cyan (K, Y, M, and C) toner images, respectively. In addition, the image forming device 1 includes a transfer unit 24, a sheet conveyance unit 28, a registration roller pair 33, a fixing device 34, a switchback device 36, and the sheet conveyance path 37. The optical writing device 2 includes a light source such as a laser diode and a light emitting diode (LED). The optical writing device 2 drives the light source to emit beams of laser light L toward four drum-shaped photoconductors 4K, 4Y, 4M and 4C. This emission of the laser light L results in formation of an electrostatic latent image on each surface of the photoconductors 4K, 4Y, 4M and 4C. This electrostatic latent image is developed into a toner image through a given development process.

The manual sheet feeding device 300 is disposed on the right side of the multifunction peripheral 100 in FIG. 1. The manual sheet feeding device 300 supplies the recording sheet stacked on the manual sheet feeding tray to a conveyance path in the image forming device 1.

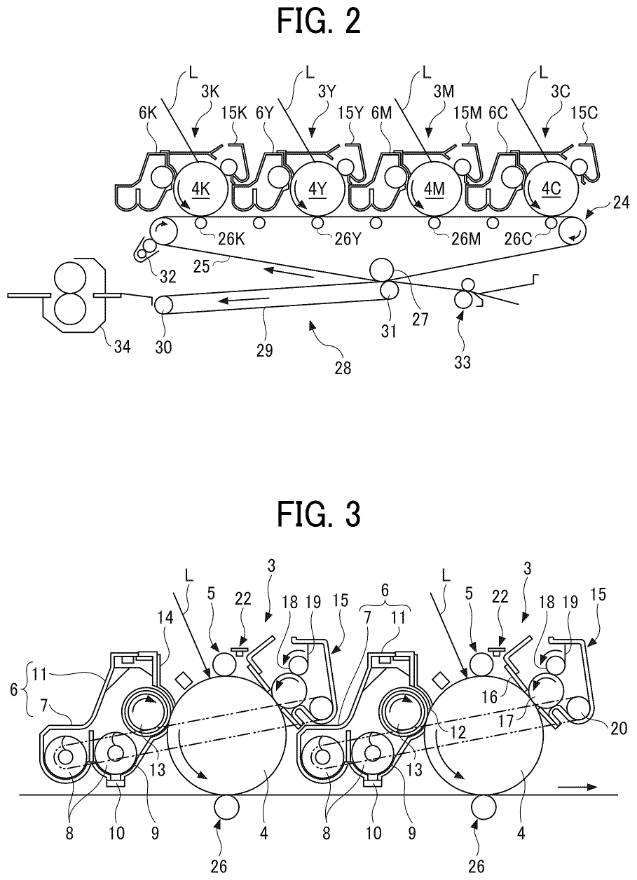

FIG. 2 is a diagram illustrating an internal configuration of a part of an image forming apparatus according to an embodiment.

FIG. 3 is a partially enlarged view of a part of a tandem section according to an embodiment.

Since the four image formation units 3K, 3Y, 3M and 3C of a tandem section have respective configurations substantially the same as each other except the toner colors, the image formation units 3K, 3Y, 3M, and 3C are also described without suffixes, which are K, Y, M and C in FIG. 3.

Each of the image formation units 3K, 3Y, 3M and 3C also includes respective various devices disposed around the corresponding one of the photoconductors 4K, 4Y, 4M and 4C, as a single unit, supported by a common support member, and is detachably attached to the image forming device 1. For the image formation unit 3K for black taken as an example, the image formation unit 3K includes a charging device 5, a developing device 6, a drum cleaning device 15, and an electric discharging lamp 22 around the photoconductor 4K. The present multifunction peripheral is a tandem image forming system in which the four image formation units 3K, 3Y, 3M and 3C are arranged in a direction of movement of an intermediate transfer belt 25 as an endless loop, which is described below.

Each of the photoconductors 4K, 4Y, 4M and 4C is manufactured by an element tube made of aluminum, for example, with a drum shape covered by a photoconductive layer formed by applying an organic photoconductive material having photosensitivity. Alternatively, the photoconductors 4K, 4Y, 4M and 4C may have an endless belt type.

The developing devices 6K, 6Y, 6M, and 6C develop a latent image by a two-component developer including magnetic carrier particles and non-magnetic toner. The developing device 6 includes an agitating portion 7 and a development portion 11. The agitating portion 7 stirs the two-component developer accommodated therein and conveys the two-component developer to a development sleeve 12. The development portion 11 supplies the non-magnetic toner, which is included in the two-component developer and held by the development sleeve 12, to the photoconductors 4K, 4Y, 4M, and 4C.

The agitating portion 7 is located at a position lower than the development portion 11 and includes two conveyance screws 8 disposed in parallel to each other, a partition disposed between the conveyance screws 8, a developing case 9, and a toner concentration sensor 10 disposed on the bottom of the developing case 9.

The development portion 11 includes the development sleeve 12, a magnetic roller 13, and a doctor blade 14. The development sleeve 12 faces the photoconductor 4 (i.e., the photoconductors 4K, 4Y, 4M and 4C) through the opening of the developing case 9. The magnetic roller 13 is unrotatably disposed inside the development sleeve 12. The leading end of the doctor blade 14 is disposed close to the development sleeve 12. The development sleeve 12 has a non-magnetic, rotatable tubular body.

The magnetic roller 13 includes multiple magnetic poles arranged in the order in a rotation direction of the development sleeve 12, starting from a position facing the doctor blade 14. Each of these magnetic poles applies a magnetic force at a given position in the rotation direction of the development sleeve 12, with respect to the two-component developer supplied on the development sleeve 12. With this action of the magnetic roller 13, the two-component developer that is conveyed from the agitating portion 7 is attracted and attached to the surface of the development sleeve 12 and a magnetic brush is formed along the lines of the magnetic force on the surface of the development sleeve 12.

In accordance with rotation of the development sleeve 12, the magnetic brush is restricted to have an appropriate layer thickness when passing by the position facing the doctor blade 14. Then, the magnetic brush is conveyed to a development region facing the photoconductors 4K, 4Y, 4M and 4C. Due to a difference of potentials between a developing bias that is applied to the development sleeve 12 and an electrostatic latent image formed on the surface of the photoconductor 4 (i.e., the photoconductors 4K, 4Y, 4M and 4C), the toner transits onto the electrostatic latent image, so that the electrostatic latent image is developed into a visible toner image.

Further, after returning into the development portion 11 again along with the rotation of the development sleeve 12 then leaving from the surface of the development sleeve 12 due to repulsion of the magnetic field formed between the magnetic poles of the magnetic roller 13, the two-component developer in a form of the magnetic brush is returned to the agitating portion 7. An appropriate amount of toner is supplied to the two-component developer in the agitating portion 7 on the basis of a result or results detected by the toner concentration sensor 10. Alternative to the two-component developer, the developing device 6 according to the present embodiment may employ one-component developer that does not include magnetic carriers.

The drum cleaning device 15 (i.e., drum cleaning devices 15K, 15Y, 15M and 15C) employs a blade member such as the cleaning blade 16 that is an elastic body to be pressed against the photoconductor 4, however, the configuration is not limited thereto. Alternative to the blade member, a brush roller, for example, can be applied to the drum cleaning device 15. The fur brush 17 according to the present embodiment is provided in order to increase the cleanability. The fur brush 17 is a contact-conductive member and the outer circumferential surface of the fur brush 17 contacts the photoconductor 4 (i.e., the photoconductors 4K, 4Y, 4M and 4C). The fur brush 17 according to the present embodiment is rotatable in a direction indicated by arrow in FIG. 3.

The fur brush 17 also functions as an applier that scrapes a solid lubricant to obtain fine powder of lubricant and applies the scraped fine powder to the surface of the photoconductor 4 (i.e., the photoconductors 4K, 4Y, 4M and 4C). The electric field roller 18 is a metallic member that applies a bias to the fur brush 17. The electric field roller 18 is disposed rotatably in a direction indicated by arrow in FIG. 3. The scraper 19 has a leading end that is pressed against the electric field roller 18. The toner attached to the fur brush 17 transits onto the electric field roller 18 that contacts the fur brush 17 in a counter direction to be applied with a bias while the electric field roller 18 is rotating. After being scraped and removed from the electric field roller 18 by the scraper 19, the toner collected by the scraper 19 falls onto the collection screw 20. The collection screw 20 conveys the toner collected from the surface of the drawing sheet toward an end portion of the drum cleaning device 15 in a direction orthogonal to the drawing sheet, and transfers the collected toner to an external toner recycling transfer device. The toner recycling transfer device sends the collected toner to the developing device 6 (i.e., developing devices 6K, 6Y, 6M and 6C) for recycling.

The electric discharging lamp 22 performs photoirradiation onto the photoconductors 4K, 4Y, 4M and 4C to remove residual electric charge remaining on the surface of the photoconductors. After such residual electric charge is removed, the electrically discharged surface of the photoconductor 4 (i.e., photoconductors 4K, 4Y, 4M and 4C) is uniformly charged by the charging device 5 again and then optically irradiated by the optical writing device 2. The charging device 5 illustrated in FIG. 3 is a charging roller that is applied with charging bias and rotates while contacting the photoconductor 4 (i.e., the photoconductors 4K, 4Y, 4M and 4C). The charging device 5 may be a scorotron charger that performs charging processing on the photoconductors 4K, 4Y, 4M and 4C in a non-contact manner.

Black (K), yellow (Y), magenta (M), and cyan (C) toner images are formed on the photoconductors 4K, 4Y, 4M and 4C of the image formation units 3K, 3Y, 3M and 3C, respectively, via the process described above. The transfer unit 24 is disposed below the image formation units 3K, 3Y, 3M and 3C. The transfer unit 24 endlessly moves the intermediate transfer belt 25 clockwise in FIG. 2 while the intermediate transfer belt 25 is stretched by and would around multiple rollers and is in contact with the photoconductors 4K, 4Y, 4M and 4C. By so doing, respective primary transfer nip regions for forming K, Y, M, and C images are formed between the photoconductors 4K, 4Y, 4M and 4C and the intermediate transfer belt 25 of an endless loop in contact with each other.

In proximity to each of the primary transfer nip regions for K, Y, M, and C images, the primary transfer rollers 26 (i.e., the primary transfer rollers 26K, 26Y, 26M and 26C) are disposed in contact with the inner loop of the intermediate transfer belt 25 to press the intermediate transfer belt 25 against the photoconductors 4 (i.e., the photoconductors 4K, 4Y, 4M and 4C), respectively. A primary transfer bias is applied by respective transfer bias power supplies to the primary transfer rollers 26K, 26Y, 26M and 26C. Consequently, respective primary transfer electric fields are generated in the primary transfer nip regions of K, Y, M, and C to electrostatically transfer respective toner images formed on the photoconductors 4K, 4Y, 4M and 4C onto the intermediate transfer belt 25.

As the intermediate transfer belt 25 passes through the primary transfer nip regions along the endless rotation clockwise in FIG. 2, K, Y, M, and C toner images are sequentially superimposed at the primary transfer nip regions and overlaid onto an outer circumferential surface of the intermediate transfer belt 25. Due to the primary transfer of the superimposed toner images, a four-color composite toner image (referred to as a four-color toner image) is formed on the outer circumferential surface of the intermediate transfer belt 25.

Below the transfer unit 24 in FIG. 2, the sheet conveyance unit 28 is disposed which includes a sheet conveyance belt 29, a drive roller 30, and a secondary transfer roller 31. The sheet conveyance belt 29 is an endless belt that is wound around the drive roller 30 and the secondary transfer roller 31 and rotates in a direction indicated by arrow in FIG. 2. The intermediate transfer belt 25 and the sheet conveyance belt 29 are sandwiched between the secondary transfer roller 31 and a lower tension roller 27 of the transfer unit 24. According to this configuration, a secondary transfer nip region is formed between the outer circumferential surface of the intermediate transfer belt 25 and the outer circumferential surface of the sheet conveyance belt 29 contacting with each other. A secondary transfer bias is applied by a transfer bias power supply to the secondary transfer roller 31. On the other hand, the lower tension roller 27 of the transfer unit 24 is electrically grounded. By so doing, a secondary transfer electric field is formed in the secondary transfer nip region.

A registration roller pair 33 is disposed on the right side of the secondary transfer nip region in FIG. 2. A registration roller sensor is disposed adjacent to an entrance of the registration nip region of the registration roller pair 33. The recording sheet is conveyed from the sheet supply device 40 to the registration roller pair 33. After a given time has elapsed since the leading end of the recording sheet is detected by the registration roller sensor, the conveyance of the recording sheet temporarily stops, and the leading end of the recording sheet contacts the registration nip region of the registration roller pair 33.

When the leading end of the recording sheet contacts the registration nip region, the registration roller pair 33 restarts the rotation to synchronize the movement of the recording sheet with the movement of the four-color toner image formed on the intermediate transfer belt 25. Consequently, the recording sheet is conveyed to the secondary transfer nip region. The four-color toner image formed on the intermediate transfer belt 25 is batch transferred onto the recording sheet in the secondary transfer nip region due to the secondary transfer electric field or the nip pressure, and the four-color toner image is combined with white color of the recording sheet to make a full-color image. After passing through the secondary transfer nip region, the recording sheet having the full-color toner image on the surface is separated from the intermediate transfer belt 25. Then, while being held on the outer circumferential surface of the sheet conveyance belt 29, the recording sheet is conveyed to the fixing device 34 along with endless rotation of the sheet conveyance belt 29.

Residual toner that has not been transferred onto the recording sheet in the secondary transfer nip region remains on the surface of the intermediate transfer belt 25 that has passed through the secondary transfer nip region. The residual toner is scraped and removed by a belt cleaning device 32 that contacts the intermediate transfer belt 25.

The recording sheet conveyed to the fixing device 34 is fixed with a full-color image by pressurization or heating in the fixing device 34, sent from the fixing device 34 to a pair of sheet ejection rollers 35, and then ejected to the outside of the apparatus.

In FIG. 1, the switchback device 36 is disposed below the sheet conveyance unit 28 and the fixing device 34. As a result of the above-described operation, the recording sheet that has completed the image fixing processing on one side is switched in the course of the recording sheet to the switchback device 36 side by the switching finger or member, is reversed, and enters the secondary transfer nip region again. Then, the recording sheet is also subjected to the secondary transfer processing and the fixing processing of the image on the other side, and then sheet ejection onto the sheet ejection tray is performed.

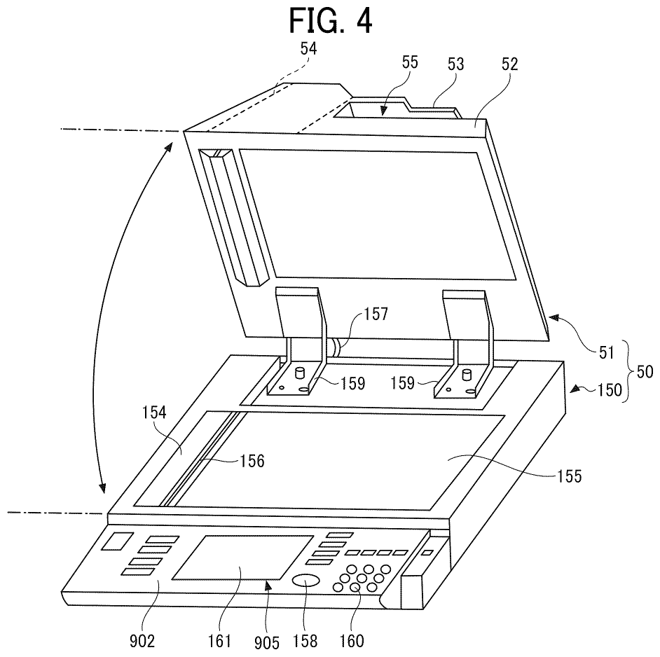

The scanner 150 secured onto the image forming device 1 includes a movable reader 152. Each of the scanner 150 and the ADF 51 includes a fixed reading unit. The movable reader 152 is disposed immediately below a second contact glass 155 (see FIG. 4) secured on a casing upper wall of the scanner 150 so as to be in contact with the document MS, and can move an optical system including a light source, and a reflection mirror in the left-right direction in FIG. 4. In the process of moving the optical system from the left side to the right side in FIG. 4, the light emitted from the light source is reflected on the document MS placed on the second contact glass 155, and then received by an image reading sensor 153 secured on the scanner main body via the multiple reflection mirrors.

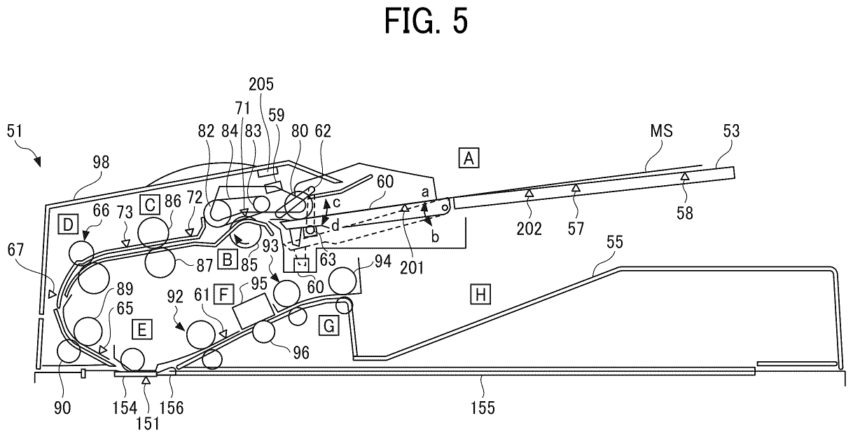

On the other hand, the fixed reading unit includes a first fixed reader 151 arranged inside the scanner 150 and a second fixed reader 95 (see FIG. 5) disposed in the ADF 51. The first fixed reader 151 including the light source, the reflection mirror, the image reading sensor such as CCD is disposed immediately below a first contact glass 154 (see FIG. 4) that is secured on the casing upper wall of the scanner 150 so as to be in contact with the document MS. When a sheet-like document MS conveyed by the ADF 51 to be described later passes over the first contact glass 154, light emitted from the light source is received by the image reading sensor via the multiple reflection mirrors while being sequentially reflected on the document surface. By doing so, the first fixed reader 151 scans the first face of the document MS without moving the optical system including the light source, and the reflection mirrors. In addition, the second fixed reader 95 scans the second face of the document MS after passing the first fixed reader 151. Note that the first fixed reader 151 and the movable reader 152 may be the same. In this case, the movable reader 152 performs reading in a state of being below the first contact glass 154, so as to function as the first fixed reader 151.

The ADF 51 that is arranged on the scanner 150 holds, on the main body cover 52, a document loading tray 53 as a document placing place that is used to place the document MS before reading. In addition, the ADF 51 holds a conveyance unit 54 with which the document MS is conveyed as a sheet member and a document stacking table 55 on which the document MS after reading is stacked.

FIG. 4 is a perspective view of a scanner and an ADF of a multifunction peripheral according to an embodiment.

As illustrated in FIG. 4, the ADF 51 is supported to be swingable in the up and down direction by hinges 159 each being secured on the scanner 150. Then, the ADF 51 moves like an opening and closing door by its swing, and exposes the first contact glass 154 and the second contact glass 155 on the upper face of the scanner 150 in an opened state. In the case of a single-bound document such as a book in which one corner of a bundle of documents is bound, the documents cannot be separated one by one, and thus conveyance by the ADF cannot be performed.

Thus, in the case of the single-bound document, after the ADF 51 is opened as illustrated in FIG. 4, the single-bound document in which a page to be read is opened is placed on the second contact glass 155 with the one-side bound document facing downward, and then the ADF is closed. Then, the scanner 150 causes the movable reader 152 illustrated in FIG. 1 to read the image on the page.

On the other hand, in the case of a bundle of documents in which multiple documents MS independent from each other are stacked, the ADF 51, while automatically conveying documents MS one by one, enables the first fixed reader 151 in the scanner 150 and the second fixed reader 95 in the ADF 51 (see FIG. 5) to sequentially read the documents MS.

In this case, the bundle of documents is set on the document loading tray 53, and then the copy start key 158 is pressed. Then, the ADF 51 sequentially feeds the documents MS of the bundle of documents placed on the document loading tray 53 into the conveyance unit 54 from the top, and while reversing, conveys the documents MS toward the document stacking table 55. In the course of this conveyance, the ADF 51 passes, immediately after reversing, the documents MS immediately above the first fixed reader 151 of the scanner 150. At this time, the image on the first face of the document MS is read by the first fixed reader 151 of the scanner 150.

FIG. 5 is an enlarged configuration diagram illustrating a main section configuration of the ADF 51 with an upper part of the scanner 150 according to an embodiment.

The ADF 51 includes a document setting part A, a separation feeding part B, a registration part C, a turning part D, a first reading conveying part E, a second reading conveying part F, a sheet ejecting part G, and a stacking part H.

In addition, the ADF 51 includes a document conveyance path for conveying the document MS from the document loading tray 53 toward the first fixed reader 151 that is an image reading position.

The document setting part A includes the document loading tray 53 on which a bundle of documents MS is placed. The separation feeding part (an example of a separator) B separates and conveys the documents MS one by one from the multiple documents MS that have been set. The registration part C temporarily contacts a fed document MS, aligning, and then feeding the document MS. The turning part D includes a curved conveying part curved in a C-shape, and in the curved conveying part, the document MS is turned and folded to be reversed upside down. The first reading conveying part E causes the first fixed reader 151 disposed inside the scanner below the first contact glass 154 to read the first face of the document MS while conveying the document MS on the first contact glass 154. The second reading conveying part F causes the second fixed reader 95 to read the second face of the document MS while conveying the document MS below the second fixed reader 95. The sheet ejector G ejects the document MS from which the images on both sides have been read toward the stack H. The stack H stacks the documents MS on the document stacking table 55.

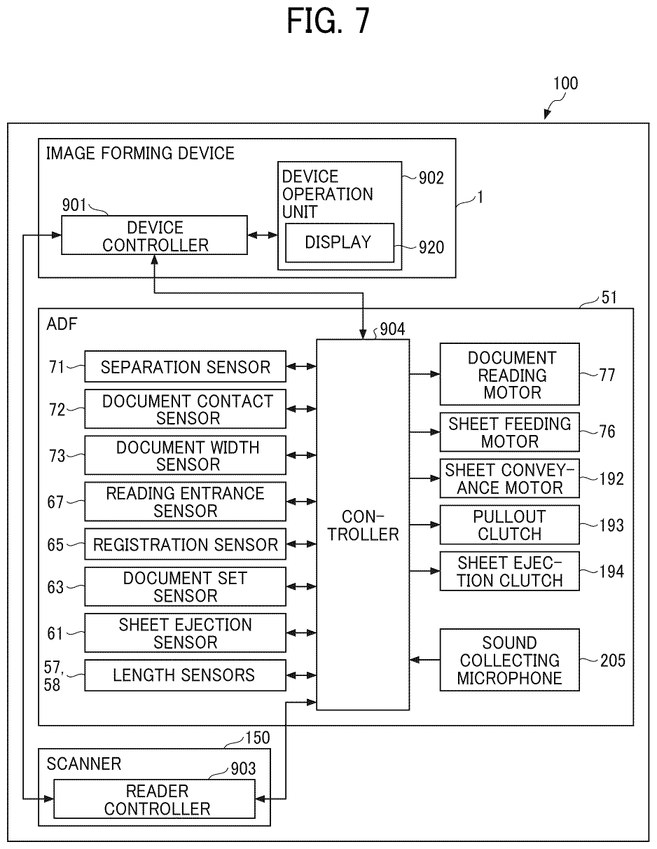

The document MS is set in a state in which the leading end portion of the document is placed on a movable document table 60 swingable in the directions of arrows a and b in FIG. 5 according to the thickness of the bundle of documents MS, and the trailing end side of the document is placed on the document loading tray 53. The position of the document MS in the width direction is adjusted with each of the side guides brought into contact with both ends in the width direction (direction orthogonal to the drawing sheet) on the document loading tray 53. The documents MS thus set push up a lever 62 that is disposed to be swingable above the movable document table 60. Along with this movement, a document set sensor 63 detects the setting of the documents MS, and transmits the detection signal to the controller 904 (see FIG. 7). The detection signal is then transmitted from the controller 904 to a reader controller 903 of the scanner 150 via an interface (I/F).

The document loading tray 53 is a tray to which a document as a reading target is set in the ADF 51.

The document loading tray 53 corresponds to, for example, the document setting part A.

The document loading tray 53 holds a first length sensor 57, a second length sensor 58, a third length sensor 202, and a fourth length sensor 201 on the document loading tray 53. Each of the first length sensor 57, the second length sensor 58, the third length sensor 202, and the fourth length sensor 201 includes a reflective photosensor or an actuator-type sensor that detects the length of the document MS in the conveyance direction of the document MS. The third length sensor 202 is, for example, a check length sensor. The fourth length sensor 201 is, for example, a business card length sensor. Hereinafter, an example in which the third length sensor 202 is a check length sensor and the fourth length sensor 201 is a business card length sensor will be described.

The first length sensor 57, the second length sensor 58, the third length sensor 202, and the fourth length sensor 201 detect the length of the document MS in the conveyance direction. The third length sensor 202 is disposed at a position where the third length sensor 202 is slightly not turned on when a check is placed on the document loading tray. The fourth length sensor 201 is disposed at a position where the fourth length sensor 201 is slightly not turned on when a business card is placed on the document loading tray.

Whether a document of specified size such as a business card or a check is placed is detected from the detection information of the first length sensor 57, the second length sensor 58, the third length sensor 202, and the fourth length sensor 201. Since the length of a check is 185 mm and the length of a business card is 91 mm, the rough indication of the position of the third length sensor 202 is 190 mm and the rough indication of the position of the fourth length sensor 201 is 96 mm, with reference to the fence against which the leading end of the document contacts when set on the document loading tray.

Above the bundle of documents MS placed on the movable document table 60, a pickup roller 80 supported by a cam mechanism so as to be movable in the up and down direction (directions of arrows c and d in FIG. 5) is disposed. The cam mechanism is driven by the pickup motor 56 to move the pickup roller 80 up and down. As the pickup roller 80 moves upward, the movable document table 60 swings in the arrow a direction in the drawing, so that the pickup roller 80 is brought to contact the uppermost document MS on the bundle of documents MS.

As the movable document table 60 further moves upward, a table elevation detection sensor 59 detects that the movable document table 60 moves up to the upper limit. In response to this detection, the pickup motor 56 stops and the movable document table 60 stops rising.

A user (operator) performs a key operation for setting a reading mode indicating a double-sided reading mode or a single-sided reading mode, a pressing operation of a copy start key 158 on a device operation unit 902 including a numeric keypad 160 provided in a main body of a multifunction peripheral, and a touch panel 161 provided in a display 920. As the copy start key 158 is pressed by the user, the document sheet feeding signal is transmitted to the controller 904 of the ADF 51 from a device controller 901 (see FIG. 7). In response to the sending of the document sheet feeding signal, the pickup roller 80 is driven and rotated along with the forward rotation of a sheet feeding motor 76, so that the documents MS on the movable document table 60 are fed from the movable document table 60.

The setting of the double-sided reading mode or the single-sided reading mode collectively covers the whole documents MS placed on the movable document table 60. To be more specific, when the double-sided reading mode or the single-sided reading mode is set, both sides or a single-side of the whole documents MS stacked on the movable document table 60 can be read. In addition, individual reading mode setting can be performed on separate ones of the documents MS. For example, the double-sided reading mode can be applied to the first and the tenth documents MS and the single-sided reading mode can be applied to the other documents MS.

The document MS fed by the pickup roller 80 enters the document separation feeding part B to be fed to the contact position with a sheet feeding belt 84. The sheet feeding belt 84 is wound and stretched by, for example, a drive roller 82 to be endlessly moved clockwise in FIG. 5 by rotation of the drive roller 82 along with the forward rotation of the sheet feeding motor 76. A sheet separation roller 85 is in contact with the lower stretched face of the sheet feeding belt 84 to be driven and rotated clockwise in FIG. 5 along with the forward rotation of the sheet feeding motor 76. At the contact portion, the sheet feeding belt 84 is rotated so that the surface of the sheet feeding belt 84 moves in the sheet feeding direction of the document MS. The sheet separation roller 85 is pressed against the sheet feeding belt 84 with a given pressure. When the sheet separation roller 85 directly contacts the sheet feeding belt 84 or a single document MS is nipped in the contact portion, the sheet separation roller 85 is rotated with rotation of the sheet feeding belt 84 or movement of the document MS. However, when multiple sheets of documents MS are nipped in the contact portion, the force of the sheet separation roller 85 to be rotated with rotation of the sheet feeding belt 84 or movement of the document MS is lower than the torque of a torque limiter. For this reason, the sheet separation roller 85 is rotated clockwise that is opposite to a direction in which the sheet separation roller 85 is rotated. As a result, the sheet separation roller 85 applies the force of movement in the direction opposite to the sheet feeding, to the documents MS under the uppermost document MS, so that the uppermost document MS alone is separated from the multiple documents MS under the uppermost document MS (the above-described operation is referred to as a sheet feeding-and-separating operation). A separation sensor 71 detects the leading end of the document MS separated into one sheet by the functions of the sheet feeding belt 84 and the sheet separation roller 85.

The document MS is separated from the other documents MS through the operations of the sheet feeding belt 84 and the sheet separation roller 85, and enters the registration part C. Then, the leading end of the document MS is detected by a document contact sensor 72 when the document MS passes directly under the document contact sensor 72. At this time, the pickup roller 80 receiving the driving force of the pickup motor 56 is still rotating. However, as the pickup roller 80 is separated from the document MS due to descendance of the movable document table 60, the document MS is conveyed only by an endless moving force of the sheet feeding belt 84. Then, the endless movement of the sheet feeding belt 84 is continued for a given time from the timing at which the leading end of the document MS is detected by the document contact sensor 72. Then, the leading end of the document MS contacts the contact portion of a pullout drive roller 86 and a pullout driven roller 87 that rotates while contacting the pullout drive roller 86.

The pullout driven roller 87 has a function of conveying the document MS to the intermediate roller pair 66 downstream side in the document conveyance direction, and is driven and rotated by the rotation of the sheet feeding motor 76 in the reverse direction. As the sheet feeding motor 76 rotates in the reverse direction, the pullout driven roller 87 and one roller of the intermediate roller pair 66 contacting the pullout driven roller 87 start rotating and the endless movement of the sheet feeding belt 84 stops. At this time, the pickup roller 80 stops rotating.

The document MS that is fed by the pullout driven roller 87 passes directly under a document width sensor 73. The document width sensor 73 includes multiple sheet detectors each including a reflective photosensor. The multiple sheet detectors are aligned in a row in the width direction of the document (i.e., the direction perpendicular to the drawing sheet). The size of the document MS in the width direction is detected based on which one of the multiple sheet detectors detects the document MS. The length of the document MS in the document conveyance direction is detected on the basis of the timing from when the leading end of the document MS is detected by the document contact sensor 72 to when the trailing end of the document MS is not detected by the document contact sensor 72.

The leading end of the document MS whose size in the width direction is detected by the document width sensor 73 enters the document turning part D and is nipped into the contact portion between the rollers of the intermediate roller pair 66. The conveyance speed of the document MS conveyed by the intermediate roller pair 66 is set faster than the conveyance speed of the document MS in the first reading conveying part E that will be described below. This configuration achieves a reduction in time for conveying the document MS to the first reading conveying part E.

As described above, the size of a document MS can be detected by the document width sensor 73, the first length sensor 57, the second length sensor 58, the third length sensor 202, and the fourth length sensor 201. On the other hand, the user can also designate the size (reading size) of the document MS with the device operation unit 902. For example, the user can select and designate the sizes of business cards (55 mm×91 mm) and checks (85 mm×185 mm) from among options for all sizes.

The leading end of the document MS conveyed in the document turning part D passes through a position where the leading end of the document MS faces a reading entrance sensor 67. As a result, when the leading end of the document MS is detected by the reading entrance sensor 67, the document conveyance speed of the document MS by the intermediate roller pair 66 is reduced until the leading end of the document MS is conveyed to the position of the scan entrance roller pair (rollers 89 and 90) downstream from the reading entrance sensor 67 in the sheet conveyance direction. As a document reading motor 77 (see FIG. 7) starts to drive and rotate, one roller of the scan entrance roller pair, one roller of a scan exit roller pair 92, and one roller of a second scan exit roller pair 93 respectively start the rotational driving.

In the document turning part D, while the document MS is conveyed in the curved conveyance path between the intermediate roller pair 66 and the scan entrance roller pair, the upper and lower faces of the document MS are reversed, and the conveyance direction of the document MS is turned back. Then, the leading end of the document MS that has passed through the nip region between the rollers of the scan entrance roller pair passes directly under a registration sensor 65. The operation up to this point after the sheet feeding-and-separating operation is referred to as a “document pullout operation”.

When the registration sensor 65 detects the leading end of the document MS, the conveyance speed of the document MS is gradually decreased through the given conveyance distance. Then, the rotational driving of the pullout drive roller 86 and the intermediate roller pair 66 are stopped due to the stop of a sheet conveyance motor 192 (see FIG. 7), and the rotational driving of the scan entrance roller pair is stopped due to the stop of the document reading motor 77. Due to this action, the conveyance of the document MS is temporarily stopped at the registration position before the first reading conveying part E. Further, a registration stop signal is transmitted to the reader controller 903.

In the present embodiment, the separation feeding part B, the registration part C, the turning part D, the first reading conveying part E, the second reading conveying part F, the sheet ejecting part G, and the stacking part H function as a conveyor that conveys a document from the document loading tray 53.

In the present embodiment, any one of the first fixed reader 151 and the second fixed reader 95 functions as a reader that reads an image represented on a document while the document is being conveyed by the above-described configuration functioning as a conveyor.

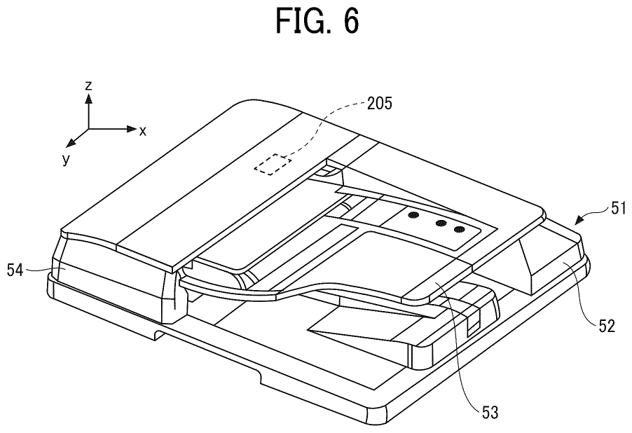

FIG. 6 is a perspective view exemplifying the ADF 51 according to the present embodiment.

In the ADF 51 illustrated in FIG. 6, a sound collecting microphone (an example of a sound collector) 205 is disposed inside the sheet feeding cover 98. The sound collecting microphone 205 is disposed in the vicinity of the conveyor, specifically, on the upstream side of the separation mechanism including the sheet feeding belt 84 and the sheet separation roller 85. For example, in a case where the documents MS are bound by clips or staples, when the uppermost document MS is to be sent in the sheet feeding direction by the sheet feeding belt 84, if the uppermost document MS is secured to the lower document MS by binding, distortion, specifically, wrinkles or folds occur in the document MS at a stage where the uppermost document MS is present on the upstream side of the sheet feeding belt 84. The sound collecting microphone 205 is disposed at a position where wrinkles or folds are estimated to occur so that the generated sound can be detected when wrinkles or folds occur.

The sound collecting microphone 205 is disposed substantially at the center in the width direction (direction orthogonal to the drawing sheet). This is because it is considered that the substantial center in the width direction (direction orthogonal to the drawing sheet) is a position where there is the highest possibility that sound can be detected when average wrinkles or folds occur in documents MS having various widths. The arrangement of the sound collecting microphone 205 illustrated in FIG. 6 is an example, and may be provided at any place as long as the sound generated when the paper jam of the document MS occurs can be measured.

The sound collecting microphone 205 is coupled to the controller 904 (see FIG. 7) to be described later. The sound information about sound collected by the sound collecting microphone 205 is converted into PCM data by an AD converter in the controller 904, and is accumulated in a RAM in the controller 904.

### System Configuration

FIG. 7 is a block diagram illustrating a part of a configuration of a multifunction peripheral 100 according to the present embodiment.

The multifunction peripheral 100 includes an image forming device 1, an ADF 51, and a scanner 150. The scanner 150 includes a reader controller 903.

The ADF 51 includes the controller 904 by which various types of equipment and sensors can be controlled. The controller 904 is coupled to a registration sensor 65, a document set sensor 63, a sheet ejection sensor 61, a separation sensor 71, a document contact sensor 72, a document width sensor 73, a reading entrance sensor 67, and length sensors 57 and 58. In addition, the document reading motor 77, the sheet feeding motor 76, the sheet conveyance motor 192, a pullout clutch 193, a sheet ejection clutch 194, and the sound collecting microphone 205 are also coupled. In addition, the ADF 51 is also coupled to the separation sensor 71, the document contact sensor 72, and the reading entrance sensor 67 for detecting the position of the document MS conveyed by the conveyor. In the ADF 51, in addition to the document contact sensor 72 and the reading entrance sensor 67, a document detection sensor may be provided on the conveyance path in order to detect the position of the document MS conveyed by the conveyor.

The image forming device 1 includes a device controller 901, and a device operation unit 902.

Each of the device controller 901 of the image forming device 1, the reader controller 903 of the scanner 150, and the controller 904 of the ADF 51 includes a CPU, a RAM, a ROM, an application specific integrated circuit (ASIC), and a storage. The device controller 901 and the reader controller 903 are coupled to communicate with each other. The reader controller 903 and the controller 904 are coupled to communicate with each other. The controller 904 and the device controller 901 are coupled to communicate with each other.

The sheet conveyance motor 192 coupled to the controller 904 is a rotation drive source for the pullout drive roller 86 and the pair of sheet ejection rollers 94 in the ADF 51. In addition, the pullout clutch 193 coupled to the controller 904 connects and disconnects the rotation driving force of the sheet conveyance motor 192 to and from the pullout drive roller 86. Further, the sheet ejection clutch 194 connects and disconnects the rotation driving force of the sheet conveyance motor 192 to and from the pair of sheet ejection rollers 94 that is used for feeding and conveying.

After receiving the registration stop signal from the controller 904, the reader controller 903 transmits a reading start signal as a sheet feeding permission signal to the controller 904. Then, the controller 904 restarts rotating the sheet conveyance motor 192 and the document reading motor. Then, the timing at which the leading end of the document MS reaches the reading position of the first fixed reader 151 is calculated on the basis of the pulse counts of the document reading motor. At this timing, the controller 904 transmits a gate signal indicating an effective image area of the first face of the document MS in a sub-scanning direction, to the reader controller 903. The controller 904 continues transmitting the gate signal until the trailing end of the document MS passes through the reading position of the first fixed reader 151, so that the first face of the document MS is read by the first fixed reader 151.

The document MS that has passed through the first reading conveying part E passes through the scan exit roller pair 92, and then the leading end of the document MS is detected by the sheet ejection sensor 61. In the case where the single-sided reading mode is set, the second face of the document MS is not to be read by the second fixed reader 95, which will be described below. Then, when the leading end of the document MS is detected by the sheet ejection sensor 61, the sheet ejection clutch 194 connects the driving force of the sheet conveyance motor to the pair of sheet ejection rollers 94. The timing at which the trailing end of the document MS passes through the nip region of the pair of sheet ejection rollers 94 is calculated on the basis of the pulse counts of the sheet ejection motor after the leading end of the document MS is detected by the sheet ejection sensor 61. Then, on the basis of the operation result, the sheet ejection clutch 194 is stopped.

On the other hand, in the case where the double-sided reading mode is set, the sheet ejection sensor 61 initially detects the leading end of the document MS. Then, the timing of the period to which the document MS reaches the second fixed reader 95 is calculated based on the pulse counts of the document reading motor. Then, at this timing, the controller 904 transmits a gate signal indicating the effective image area of the second face of the document MS in the sub-scanning direction, to the reader controller 903. The controller 904 continues transmitting the gate signal until the trailing end of the document MS passes through the reading position of the second fixed reader 95, so that the second face of the document MS is read by the second fixed reader 95.

The second fixed reader 95 includes contact-type image sensors (CIS) and is provided with coating on the reading face for the purpose of preventing reading vertical streaks due to the paste-like foreign substance adhering to the document MS from adhering to the reading face. A second reading roller 96 as a document supporter that supports the document MS from a non-reading face is disposed at a position facing the second fixed reader 95. The second reading roller 96 functions as a floating retainer that prevents the document MS from floating up at the reading position by the second fixed reader 95 and as a reference white portion for acquiring in the shading data on the second fixed reader 95.

### Features of MFP of Present Embodiment

The ADF 51 according to the present embodiment can read information indicated in the document MS by performing the above-described processing. In the ADF 51, there is a possibility that a conveyance abnormality such as a paper jam occurs in the above-described mechanism.

In the conventional ADF (automatic document feeder), when the occurrence of the conveyance abnormality is determined based on the sound acquired at the time of sheet feeding/separation, in an environment where noise is generated, there is a possibility that the conveyance sound is erased by the noise as an obstacle at the time of collecting the conveyance sound used for determination and erroneous determination is made. In the case where erroneous determination occurs, the operation of the ADF is also stopped. In this case, since the user needs to manually disable the conveyance abnormality determination function and then perform an operation for starting printing again, an operation burden and stress of the user occur.

Then, the multifunction peripheral 100 according to the present embodiment has a configuration for determining whether the detection of conveyance abnormality by sound is executed on the basis of the sound collected by the sound collecting microphone 205.

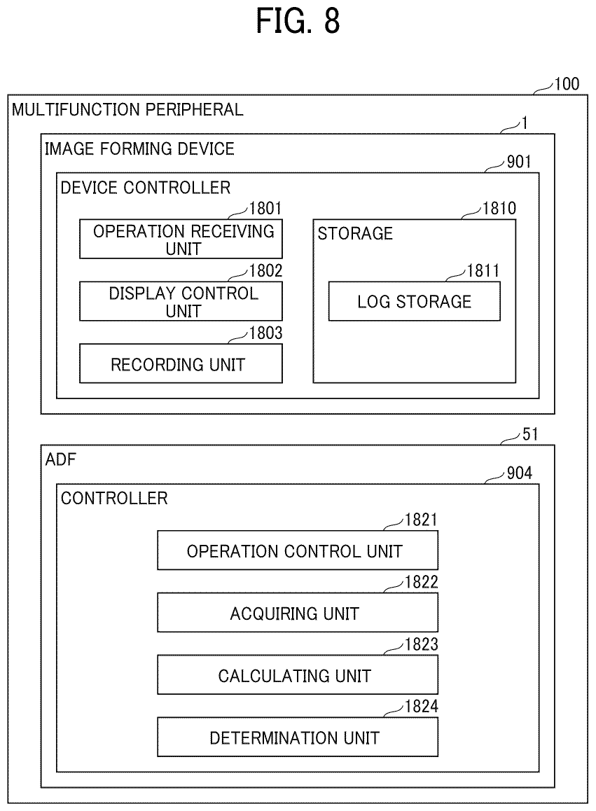

FIG. 8 is a diagram exemplifying a software configuration of the device controller 901 and the controller 904 according to the present embodiment.

The device controller 901 of the image forming device 1 causes the CPU to execute a program stored in the ROM, so as to implement an operation receiving unit 1801, a display control unit 1802, and a recording unit 1803. Further, the device controller 901 includes a log storage 1811 in a storage 1810 in the device controller 901.

The log storage 1811 stores, in the storage 1810, information related to the multifunction peripheral 100 as a log. For example, the log storage 1811 stores information indicating whether the detection of the conveyance abnormality is skipped and the date and time in association with each other.

The operation receiving unit 1801 performs control for receiving an operation performed on the device operation unit 902.

The display control unit 1802 control to display information on the display 920.

The recording unit 1803 is configured to record information related to the multifunction peripheral 100 in the log storage 1811 as a log.

The controller 904 of the ADF 51 causes the CPU to execute a program stored in the ROM, so as to implement an operation control unit 1821, an acquiring unit 1822, a calculating unit 1823, and a determination unit 1824.

The operation control unit 1821 controls an operation such as automatic conveyance by the ADF 51.

The acquiring unit 1822 acquires various types of information input to the controller 904 and detection results of various sensors. For example, the acquiring unit 1822 acquires sound data collected by the sound collecting microphone 205.

The calculating unit 1823 calculates an acoustic feature amount from the sound data acquired by the acquiring unit 1822.

The calculating unit 1823 performs short-time Fourier transform (STFT) on the sound data collected during a given time interval t every given time interval t to calculate a power spectrum of the sound data. The calculating unit 1823 applies a high-pass filtering to the calculated power spectrum to remove sound components of 12.5 kHz or less. The reason why the sound component of 12.5 kHz or less is removed is to suppress the influence of the drive sound (mainly, 10 kHz or less) of the sheet feeding motor 76.

The calculating unit 1823 derives the average of the power values for each frequency band with respect to the power spectrum subjected to the high-pass filtering, so as to calculate the average value of the sound intensity in all the frequency bands. Further, the calculating unit 1823 performs decibel conversion on the calculated average value of the sound intensity, so as to calculate a sound intensity level. The calculating unit 1823 accumulates the sound intensity level derived from the start of the sheet feeding-and-separating operation by the ADF 51 in the RAM.

The determination unit 1824 determines whether an abnormality has occurred in the conveyance of the document MS by the conveyor on the basis of the sound data collected by the sound collecting microphone 205. Specifically, every time the sound intensity level is calculated, the determination unit 1824 determines whether the sound intensity level is larger than a threshold. The threshold is determined according to an implementation mode such as the performance of the multifunction peripheral 100 and the surrounding environment.

Then, the determination unit 1824 counts the number of times (referred to as a count value C) at which the sound intensity level has become larger than the threshold since the start of the sheet feeding-and-separating operation by the ADF 51.

The determination unit 1824 determines whether the count value C exceeds a predetermined reference count value. When the determination unit 1824 determines that the count value C exceeds the predetermined reference count value, it is regarded as abnormal conveyance, and the operation control unit 1821 stops the operation such as automatic conveyance by the ADF 51.

Further, the determination unit 1824 determines whether the sound collected by the sound collecting microphone 205 during the given period satisfies the given condition in order to switch whether to skip the determination as to whether the abnormality occurs in the conveyance of the document MS by the conveyor. In the present embodiment, the given period is a period from when the copy start key is pressed to when the sheet feeding-and-separating operation is started, but is not limited to this period. Further, in the present embodiment, the given condition is a case where the collected sound has a given volume or more, specifically, a case where the intensity level of the collected sound is a given level or more, but is not limited to a case where the collected sound has the given volume or more.

### Process Flow

A flow of the conveyance processing performed by the ADF 51 according to the present embodiment will be described.

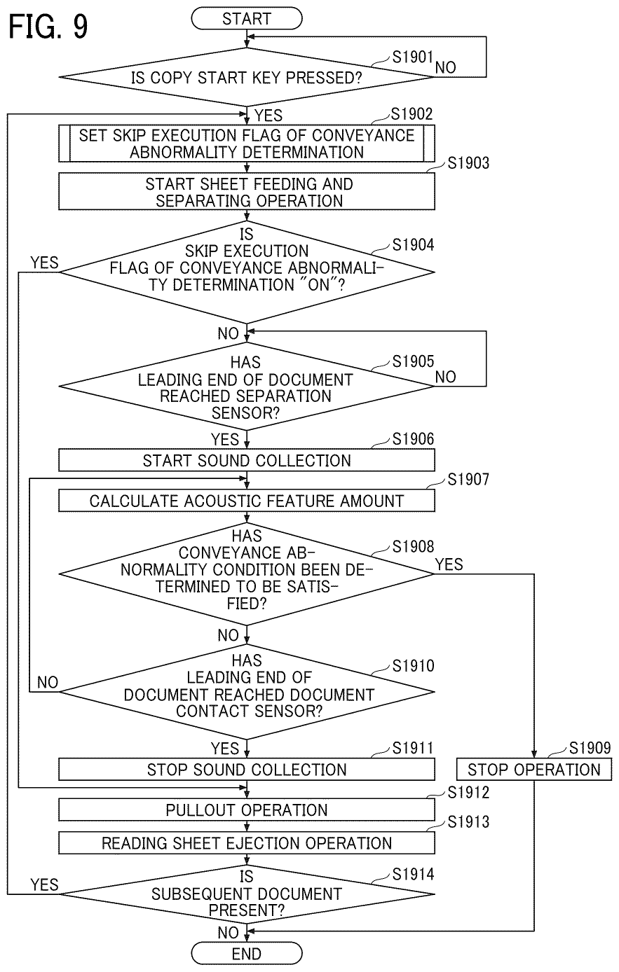

FIG. 9 is a flowchart exemplifying a procedure of a conveyance processing in the multifunction peripheral 100 according to the first embodiment.

It is determined whether the operation receiving unit 1801 of the device controller 901 of the image forming device 1 has accepted pressing of the copy start key of the device operation unit 902 (step S1901). When the operation receiving unit 1801 determines that pressing of the copy start key has not been received (NO in step S1901), the determination in step S1901 is performed until the pressing of the copy start key is received.

When the operation receiving unit 1801 determines that pressing of the copy start key of the device operation unit 902 has been accepted (YES in step S1901), a document sheet feeding signal corresponding to the accepted operation is transmitted to the controller 904 of the ADF 51.

Then, the device controller 901 of the image forming device 1 and the controller 904 of the ADF 51 set a skip execution flag for conveyance abnormality determination (step S1902). A specific process of setting the skip execution flag will be described later. In the following processing, “ON” or “OFF” is set as the skip execution flag according to the surrounding sound situation. For example, the skip execution flag “ON” is set if the surrounding sound is equal to or higher than a given level, and the skip execution flag “OFF” is set if the surrounding sound is lower than the given level.

In the multifunction peripheral 100 according to the present embodiment, the operation of separating and feeding the documents MS one by one from the bundle of documents MS set in the document loading tray 53 is performed for each of the documents MS in and after step S1902. The ADF 51 continuously performs the feeding operation of the documents MS with an interval to such an extent that the documents MS do not overlap each other in order to increase the throughput of reading, and thus, multiple documents MS are simultaneously present with an interval in the document conveyance path. Therefore, in practice, the processing in and after step S1902 in FIG. 9 is executed in parallel at intervals for each document MS.

The operation control unit 1821 of the controller 904 of the ADF 51 starts the sheet feeding-and-separating operation in accordance with the received document sheet feeding signal (step S1903). Specifically, the pickup roller 80 starts an operation of being rotationally driven by the normal rotation of the sheet feeding motor 76, thereby feeding the document MS on the movable document table 60 from the movable document table 60.

The operation control unit 1821 determines whether the skip execution flag of the conveyance abnormality determination is “ON” (step S1904). When the operation control unit 1821 determines that the skip execution flag of the conveyance abnormality determination is “ON” (YES in step S1904), the operation control unit 1821 skips (does not perform) the conveyance abnormality determination and proceeds to the processing of step S1912.

When the operation control unit 1821 determines that the skip execution flag of the conveyance abnormality determination is “OFF” (NO in step S1904), the operation control unit 1821 determines that the conveyance abnormality determination is not skipped and proceeds to the processing of step S1905.

The operation control unit 1821 determines whether the leading end of the document MS has reached the detection position of the separation sensor 71 (step S1905). When the operation control unit 1821 determines that the leading end of the document MS has not reached (NO in step S1905), the operation control unit 1821 repeats the processing of step S1905 again.

On the other hand, if the operation control unit 1821 determines that the leading end of the document MS has reached the detection position of the separation sensor 71 (YES in step S1905), the acquiring unit 1822 starts acquisition of sound data indicating the document conveyance sound during separation/sheet feeding collected by the sound collecting microphone 205 (step S1906). The acquired sound data is stored in the RAM of the controller 904. The acquisition of the sound data is continuously performed until it is determined in step S1910 that the leading end of the document MS has arrived.

The calculating unit 1823 calculates the acoustic feature amount from the sound data stored in the RAM (step S1907). The acoustic feature amount is, for example, a sound intensity level. The method for calculating the acoustic feature amount is as described above, and the description thereof will be omitted.

The determination unit 1824 determines whether the condition of the conveyance abnormality is satisfied on the basis of the calculated acoustic feature amount (step S1908). As the condition of the conveyance abnormality, it is determined whether the count value C, which is calculated by the above-described method, indicating the number of times the intensity level of the sound becomes larger than the threshold, exceeds a predetermined reference count value. When the determination unit 1824 determines that the count value C exceeds the reference count value, it is determined that the conveyance abnormality has occurred.

When the determination unit 1824 determines that the condition of the conveyance abnormality is satisfied on the basis of the calculated acoustic feature amount (YES in step S1908), the operation control unit 1821 stops the operation for performing the conveyance processing (step S1909) and ends the process.

On the other hand, when the determination unit 1824 determines that the condition of the conveyance abnormality is not satisfied on the basis of the calculated acoustic feature amount (step S1908: NO), the operation control unit 1821 determines whether the leading end of the document MS has reached the detection position of the document contact sensor 72 (step S1910). When the operation control unit 1821 determines that the detection position of the document contact sensor 72 has not been reached (NO in step S1910), the processing is performed again from step S1907. That is, the processing of steps S1907 to S1910 is repeated until the leading end of the document MS reaches the detection position of the document contact sensor 72.

On the other hand, when the operation control unit 1821 determines that the leading end of the document MS has reached the detection position of the document contact sensor 72 (YES in step S1910), the acquiring unit 1822 stops acquiring sound data collected by the sound collecting microphone 205 (step S1911).

Thereafter, the operation control unit 1821 performs a pullout operation (step S1912).

Further, the operation control unit 1821 performs a read paper ejection operation (step S1913).

Then, the operation control unit 1821 determines whether the subsequent document MS to be read is present in the tray (step S1914). When the operation control unit 1821 determines that the subsequent document MS is present on the tray (NO in step S1914), the operation control unit 1821 performs the processing from step S1902 again.

On the other hand, when the operation control unit 1821 determines that the subsequent document MS to be read is not present in the tray (NO in step S1914), the operation control unit 1821 ends the processing.

In multifunction peripheral 100 according to the present embodiment, whether to skip the conveyance abnormality determination (process) is switched according to the surrounding sound by the above-described processing procedure.

Even in the case where the ADF 51 performs conveyance normally, when the document MS enters the contact portion between the sheet feeding belt 84 and the sheet separation roller 85, the leading end of the document MS is not necessarily conveyed straight to the contact position. In the case of not being conveyed straight to the contact position, the leading end of the document MS enters the conveyance nip region while being in contact with the sheet feeding belt 84 or the sheet separation roller 85. At this time, a collision sound is generated from the document MS.

In addition, the document MS is brought into contact with an contact portion between the pullout drive roller 86 and the pullout driven roller 87, so that skew correction of the document MS is performed. Even when skew correction is performed, a collision sound is generated from the document MS.

In the case of supposing that the controller performs the determination for a certain period of time from the start of the sheet feeding-and-separating operation, there is a possibility that the count value C exceeds the reference count value due to the collision sound to the separation-contact part, and erroneous determination occurs as abnormal conveyance despite normal conveyance.

Furthermore, the leading end position of the document is not constant due to entry of the subsequent document due to slip at the time of conveying the document or entanglement feeding at the time of separation. For this reason, in the case where the sound collection time of the sound collecting microphone and the determination time of the controller are set to a certain period of time, there is a possibility that the determination of the controller ends even though the document still is present at a position where the sound collection and the determination can be performed.

For this reason, in the present embodiment, as in the processing procedure illustrated in FIG. 9, sound collection is started after the separation sensor 71 detects the arrival of the leading end of the document. Since the start timing of the sound collection is when the separation sensor 71 detects the arrival of the leading end of the document, it is possible to suppress the collision sound in the separator from being included in the count value C. Therefore, erroneous determination can be suppressed.

In the controller 904 according to the present embodiment, on the basis of a position of the documents MS detected by the separation sensor 71 (an example of the detector), a period after the leading end of the document MS passes through the separator is set as a period in which the sound collecting microphone 205 performs sound collection. Instead of the period in which the sound collecting microphone 205 starts the sound collection, the period in which the determination unit 1824 determines whether the abnormality occurs in the conveyance of the document MS may be set as the period after the position where the leading end of the document MS passes through the separator. Therefore, in the present embodiment, since the collision sound of the document in the separator is not included in the conveyance abnormality count, erroneous detection can be prevented.

Furthermore, the sound collection by the sound collecting microphone 205 and the determination by the controller 904 are repeatedly performed until the leading end of the document reaches the detection position of the document contact sensor 72, so that even when a document with a large slip is conveyed, the determination can be continued until the conveyance of the document is completed, and thus the determination accuracy can be improved.

In the controller 904 according to the present embodiment, a period until the leading end of the document MS is detected to reach the contact portion by the document contact sensor 72 (an example of the detector) is a period in which the determination unit 1824 determines whether an abnormality has occurred in the conveyance of the document. In addition, a period until the leading end of the document MS is detected to reach the contact portion by the document contact sensor 72 (an example of the detector) is also a period in which the sound collecting microphone 205 collects sound.

In the present embodiment, the determination of the conveyance abnormality is continuously performed until the document contact sensor 72 detects the leading end of the document MS, so that even in the case where the document MS with a large slip is conveyed, it is possible to perform the determination until the document MS is conveyed, and it is possible to suppress the influence of the collision sound between the contact portion and the document MS on the determination of the conveyance abnormality. Therefore, the controller 904 according to the present embodiment can improve the determination accuracy.

The processing procedure illustrated in FIG. 9 is an example, and is not limited to this procedure. For example, the start of sound collection in step S1906 and the calculation of the acoustic feature amount in step S1907 may be performed after the sheet feeding-and-separating operation starts in step S1903 until the leading end of the document MS is detected to reach the contact portion by the document contact sensor 72 in step S1910.

Then, setting of the skip execution flag of the conveyance abnormality determination in the multifunction peripheral 100 in step S1902 of FIG. 9 will be described.

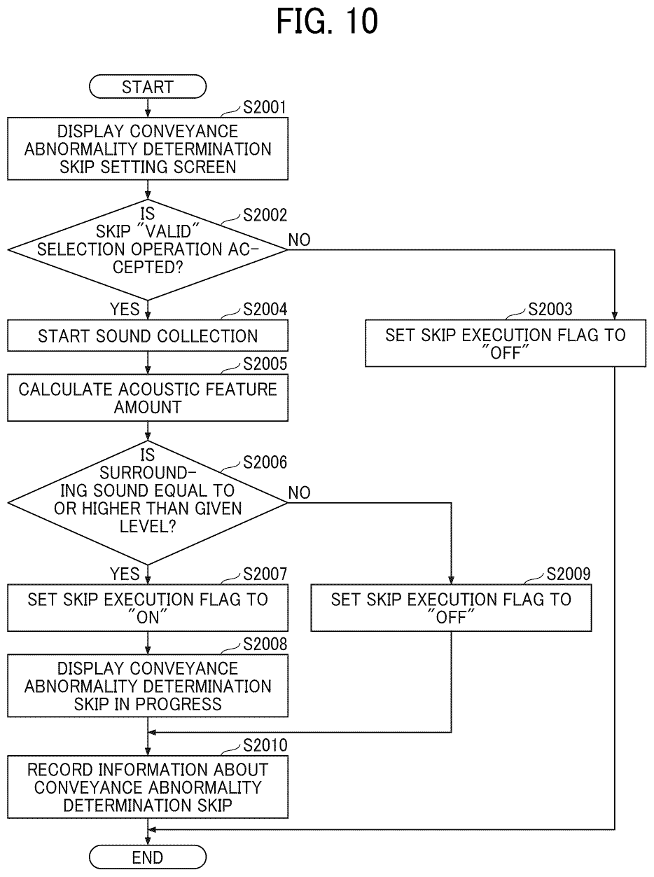

FIG. 10 is a flowchart exemplifying a procedure of setting processing of a skip execution flag of conveyance abnormality determination in the device controller 901 of the image forming device 1 and the controller 904 of the ADF 51 according to the first embodiment.

First, the display control unit 1802 displays a conveyance abnormality determination skip setting screen (step S2001).

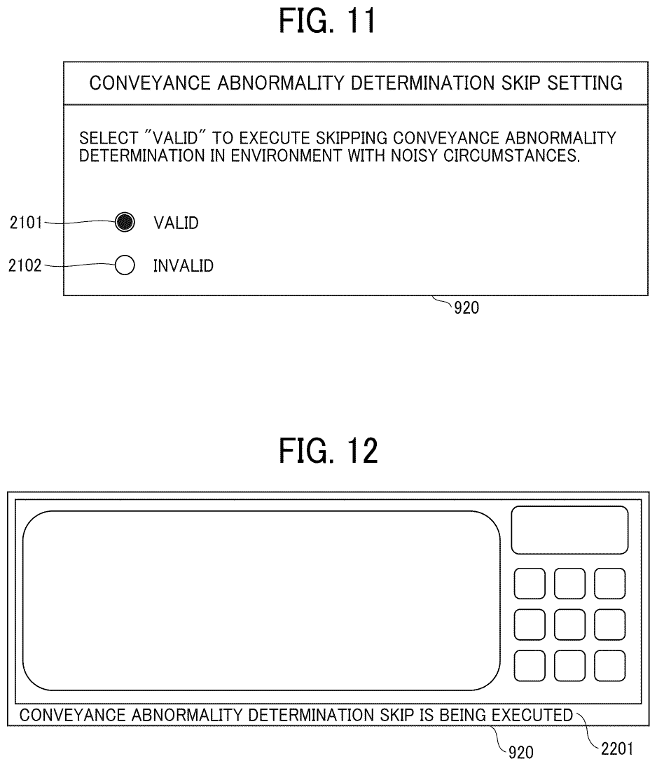

FIG. 11 is a diagram exemplifying a conveyance abnormality determination skip setting screen displayed by the display control unit 1802 according to the first embodiment.

As illustrated in FIG. 11, a “VALID” button 2101 and a “INVALID” button 2102 are selectively displayed as the conveyance abnormality determination skip. The “VALID” button 2101 is a radio button for enabling the skipping function of the conveyance abnormality determination according to the surrounding sound. The “INVALID” button 2102 is a radio button for disabling the skipping function of the conveyance abnormality determination according to the surrounding sound.

Returning to FIG. 10, the operation receiving unit 1801 determines whether a selection operation of skip “VALID” is accepted on the conveyance abnormality determination skip setting screen (step S2002). When the operation receiving unit 1801 has accepted the selection operation, the device controller 901 notifies the controller 904 of a result of whether the skipping function of the conveyance abnormality determination is enabled.

When the operation receiving unit 1801 has accepted the pressing of the “INVALID” button 2102, in other words, in the case where it is determined that the selection operation of skip “VALID” is not accepted (NO in step S2002), “OFF” is set as the skip execution flag of the conveyance abnormality determination (step S2003), and the process is ended.

On the other hand, when the operation receiving unit 1801 has accepted the pressing of the “VALID” button 2101, in other words, it is determined that the selection operation of skip “VALID” has been accepted (YES in step S2002), the acquiring unit 1822 starts acquiring sound data indicating the surrounding sound collected by the sound collecting microphone 205 (step S2004). The acquired sound data is stored in the RAM of the controller 904.

The acquired sound data includes sound data in a band from a low sound to a high sound, and includes, for example, noise due to construction or high sound noise generated from the main body of the multifunction peripheral 100 or the ADF 51.

In the multifunction peripheral 100 according to the present embodiment, whether to perform determination is switchable according to the operation accepted by the operation receiving unit 1801. In the multifunction peripheral 100, whether the conveyance abnormality determination is skipped is selected by the user. Therefore, even in a case where the multifunction peripheral 100 stops the operation due to erroneous determination of conveyance abnormality determination, since the result corresponds to the request of the user, it is possible to suppress the stress due to the stop of the operation.

The calculating unit 1823 calculates the acoustic feature amount from the sound data stored in the RAM (step S2005). The acoustic feature amount is, for example, the above-described sound intensity level. The method for calculating the acoustic feature amount is as described above, and the description thereof will be omitted.

The determination unit 1824 determines whether the sound intensity level of the surrounding sound is equal to or higher than a given level (step S2006). The given level is determined according to an implementation mode of the surrounding environment.

If the determination unit 1824 determines that the sound intensity level due to the surrounding sound is equal to or higher than the given level (YES in step S2006), the determination unit 1824 sets “ON” in the skip execution flag of the conveyance abnormality determination (step S2007). Then, the controller 904 outputs information indicating that the conveyance abnormality determination is skipped to the device controller 901.

Then, the display control unit 1802 of the device controller 901 displays that the conveyance abnormality determination is being skipped on the display 920 according to the information received from the controller 904 (step S2008).

FIG. 12 is a diagram illustrating an example of a screen displayed by the display control unit 1802 of the device controller 901 according to the first embodiment.

The screen example illustrated in FIG. 12 is, for example, a screen displayed while the copy processing is being performed, and a message 2201 is displayed in the lower field of the screen. Since the message 2201 displays “CONVEYANCE ABNORMALITY DETERMINATION SKIP BEING EXECUTED”, the user can recognize that the conveyance abnormality determination is being skipped.

In other words, if the determination as to whether the abnormality is generated is skipped, the display 920 displays “CONVEYANCE ABNORMALITY DETERMINATION SKIP BEING EXECUTED” as the information indicating that the determination is skipped. Therefore, the user can recognize whether the conveyance abnormality determination is skipped by referring to the display 920.

Returning to FIG. 10, when determining that the sound intensity level due to the surrounding sound is lower than the given level (NO in step S2006), the determination unit 1824 sets “OFF” in the skip execution flag of the conveyance abnormality determination (step S2009).

After the process of step S2008 or step S2009, the recording unit 1803 records information related to skipping of the conveyance abnormality determination based on the determination result by the determination unit 1824 in the log storage 1811 (step S2010). For example, the recording unit 1803 records information indicating the skip execution state together with the current date and time in the log storage 1811.

In this manner, when the determination as to whether the conveyance abnormality occurs is skipped, the recording unit 1803 records the information indicating that the determination is skipped in the log storage 1811. Therefore, since the log from which the conveyance abnormality determination has been skipped is stored, it is easy to grasp the situation by referring to the log when a failure occurs.

In the present embodiment, in the case where it is recognized that the sound with the sound intensity level equal to or higher than the given level is not collected in the given period from when the pressing of the copy start key of the device operation unit 902 is accepted to when the sheet feeding-and-separating operation is started, the determination unit 1824 sets “OFF” to the skip execution flag of the conveyance abnormality determination and starts the determination as to whether the abnormality occurs in the conveyance of the document MS by the conveyor. Therefore, the conveyance abnormality determination is not skipped when the magnitude of a noise detected in the given period is below the given level, so that the determination accuracy of the conveyance abnormality determination can be improved.

In this manner, in the present embodiment, the given period for determining whether to skip the conveyance abnormality determination (process) is from when the pressing of the copy start key of the device operation unit 902 is accepted to when the sheet feeding-and-separating operation is started, in other words, when the multifunction peripheral 100 (as an image forming apparatus) provided with the ADF 51 is in operation.

In the multifunction peripheral 100 according to the present embodiment, it is determined whether to execute skipping of the conveyance abnormality determination in consideration of the noise of the use environment based on the surrounding sound before sheet feeding. Therefore, the determination accuracy of the conveyance abnormality determination is improved. Furthermore, in the multifunction peripheral 100, it is possible to reduce stress due to erroneous determination.

The multifunction peripheral 100 according to the present embodiment has the above-described configuration, which makes it possible to suppress occurrence of erroneous determination of conveyance abnormality due to noise around the multifunction peripheral 100 or high sound noise generated from the multifunction peripheral 100 or the ADF 51.

### Modification of First Embodiment

In the above-described embodiment, an example in which the operation is stopped when the condition of the conveyance abnormality is satisfied has been described. However, even when the conveyance abnormality condition is satisfied, there is the case where it is desired to continue reading the document. In the modification, an example in which the document reading can be continued even when the condition of the conveyance abnormality is satisfied will be described.

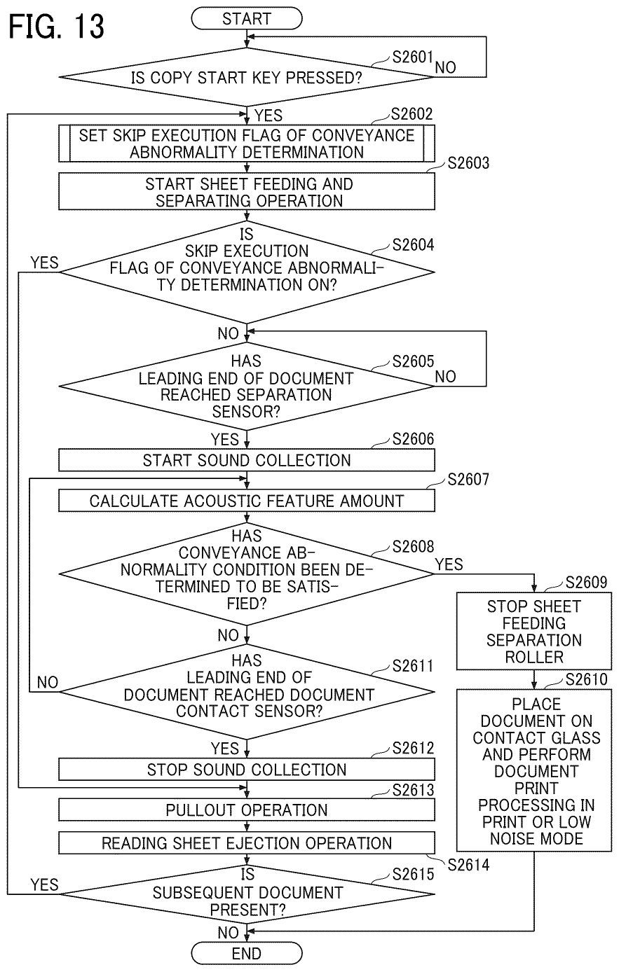

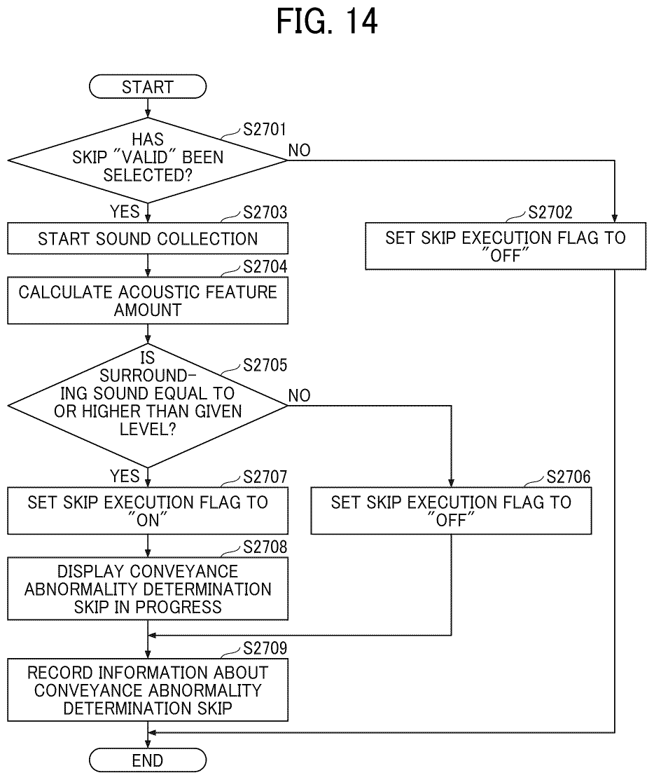

FIG. 13 is a flowchart exemplifying a procedure of a conveyance processing in the multifunction peripheral 100 according to the modification of the first embodiment.

The processing from steps S2601 to S2608 and steps S2611 to S2615 illustrated in FIG. 13 is similar to the processing from steps S1901 to S1908 and steps S1910 to S1914 in FIG. 9.

In step S2608, when the determination unit 1824 determines that the condition of the conveyance abnormality is satisfied on the basis of the calculated acoustic feature amount (YES in step S2608), the operation control unit 1821 stops the sheet separation roller 45 (step S2609).

Then, the multifunction peripheral 100 performs printing processing on the documents MS placed one by one on the contact glass 155 according to the operation from the user, or continues the printing processing of the documents MS in the silent mode (step S2610). That is, when the conveyance abnormality occurs in the ADF 51, there is a possibility that the conveyance abnormality occurs again in the case where the printing process using the ADF 51 is continued. Thus, the multifunction peripheral 100 prompts the user to perform the printing processing using the contact glass 155 or continues the printing processing using the silent mode in which the conveyance speed is reduced, so that the printing processing of the document MS can be performed to the end.

The multifunction peripheral 100 according to the present modification can continue the printing process to the end even when the conveyance abnormality occurs. Therefore, the reliability of the multifunction peripheral 100 can be improved.

### Second Embodiment

In the above-described embodiment and the modification, an example is described in which after the pressing of the copy start key of the device operation unit 902 is accepted, whether to skip the conveyance abnormality determination (process) is determined on the basis of the surrounding sound. However, the above-described embodiment and the modification are not limited to the mode in which after the pressing of the copy start key of the device operation unit 902 is accepted, whether to skip the conveyance abnormality determination (process) is determined on the basis of the surrounding sound. Thus, in the second embodiment, an example is described in which the multifunction peripheral 100 continues to repeatedly determine whether to skip the conveyance abnormality determination (process) on the basis of the surrounding sound.

FIG. 14 is a flowchart exemplifying a procedure of setting processing of a skip execution flag of conveyance abnormality determination in the device controller 901 of the image forming device 1 and the controller 904 of the ADF 51 according to the second embodiment.

In the processing procedure illustrated in FIG. 14, the operation receiving unit 1801 has accepted a selection operation of “VALID” or “INVALID” in advance on the conveyance abnormality determination skip screen illustrated in FIG. 11. Then, the device controller 901 of the image forming device 1 and the controller 904 of the ADF 51 repeatedly perform the process illustrated in FIG. 14 at given time intervals when the printing process by the multifunction peripheral 100 (as an image forming apparatus) is not in operation.

Specifically, the controller 904 of the ADF 51 determines whether “VALID” has been selected on the conveyance abnormality determination skip screen (step S2701). When it is determined that the “VALID” has not been selected (NO in step S2701), “OFF” is set as the skip execution flag of the conveyance abnormality determination (step S2702), and the processing is ended.

On the other hand, when it is determined that the “VALID” has been selected on the conveyance abnormality determination skip screen (YES in step S2702), the controller 904 of the ADF 51 performs processing for setting the skip execution flag as in steps S2004 to S2010 of FIG. 10 (steps S2703 to S2709).

When the multifunction peripheral 100 according to the present embodiment performs the conveyance processing, the processing is performed according to the flowchart illustrated in FIG. 9. However, the multifunction peripheral 100 does not perform only the processing of step S1902, and uses the skip execution flag of the conveyance abnormality determination set by the repetitive processing at given time intervals as illustrated in FIG. 14 in step S1904.

In this manner, in the present embodiment, the given period for determining whether to skip the conveyance abnormality determination (process) includes a time when the multifunction peripheral 100 (as an image forming apparatus) provided with the ADF 51 is not in operation.

In the multifunction peripheral 100 according to the present embodiment, it is determined whether to execute skipping of the conveyance abnormality determination in consideration of the noise of the use environment based on the surrounding sound when the multifunction peripheral 100 (as an image forming apparatus) is not in operation. Therefore, the determination accuracy of the conveyance abnormality determination is improved. Furthermore, in the multifunction peripheral 100, it is possible to reduce stress due to erroneous determination.

In the present embodiment, since the skip execution flag of the conveyance abnormality determination corresponding to the surrounding situation is always set, the accuracy of the conveyance abnormality determination skip can be improved. Therefore, the determination accuracy of the conveyance abnormality determination can be improved.

### Third Embodiment

In the above-described embodiment and the modification, an example has been described in which whether to skip the conveyance abnormality determination (process) is determined according to whether the sound level due to the surrounding sound is equal to or higher than the given level. However, in the above-described embodiment and the modification, the method for determining whether to skip the conveyance abnormality determination (process) is not limited. Thus, in the third embodiment, an example in which a trained model is used for determining whether the collected sound satisfies a given condition will be described.

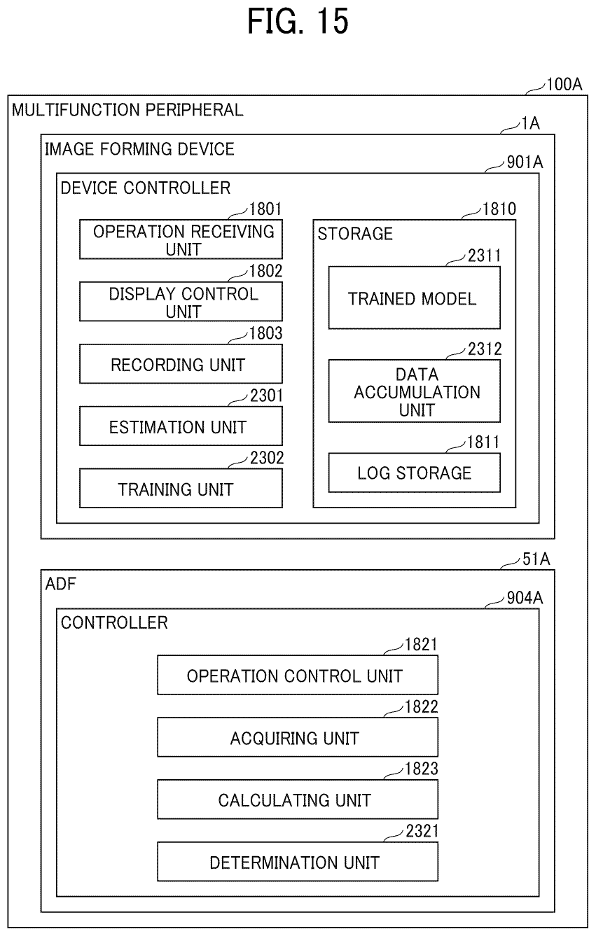

FIG. 15 is a diagram exemplifying a software configuration of the multifunction peripheral 100A according to the present embodiment.

The same reference numerals are assigned to the configurations similar to the configurations in FIG. 9, and the description thereof will be omitted. The image forming device 1A of the multifunction peripheral 100A and the ADF 51A according to the present embodiment have a software configuration that can implement estimation using a trained model. The same reference numerals are assigned to the configurations similar to the configurations in FIG. 9 among the configurations included in the image forming device 1A and the ADF 51A, and the description thereof will be omitted.

The device controller 901A of the image forming device 1 causes a CPU to execute a program stored in the ROM to implement an estimation unit 2301 and a training unit 2302 in addition to the operation receiving unit 1801, the display control unit 1802, and the recording unit 1803. Furthermore, the device controller 901 includes a trained model 2311 and a data accumulation unit 2312 in addition to the log storage 1811 in the storage 1810 in the device controller 901.

For example, in the case where sound data collected by the sound collecting microphone 205 is input, the trained model 2311 outputs a determination result as to whether to execute skipping of the abnormality determination. However, in the present embodiment, the information output from the trained model 2311 is not limited to the determination result as to whether to execute skipping of the abnormality determination, and the intensity level of the sound representing the surrounding sound may be output. That is, the information output from the trained model 2311 may be any information based on which whether to execute skipping of the conveyance abnormality determination can be determined.

The data accumulation unit 2312 stores sound data collected by the sound collecting microphone 205 and information indicating whether to execute skipping of abnormality determination in association with each other. In addition, in the case where the information output from the trained model 2311 is the sound intensity level representing the surrounding sound, the data accumulation unit 2312 may store the sound data collected by the sound collecting microphone 205 and the intensity level of the collected sound data in association with each other.

The estimation unit 2301 inputs sound data input from the controller 904A to the trained model 2311 to receive a determination result as to whether to execute skipping of abnormality determination, and outputs the determination result to the controller 904A. In addition, the estimation unit 2301 may input sound data input from the controller 904A to the trained model 2311, so as to receive the sound intensity level. In this case, similarly to the above-described embodiment, the controller 904A determines whether to execute skipping of the abnormality determination according to whether the intensity level of the received sound is equal to or higher than a given level.

The training unit 2302 uses the information stored in the data accumulation unit 2312 as teacher data, to perform generation and additional learning of the trained model 2311.

As the machine learning used for the generation of the training unit 2302, for example, a neural network may be applied, or deep learning may be applied which is machine learning using a deep neural network (DNN). As the deep learning, for example, a convolutional neural network, a recurrent neural network (RNN), or a long-short term memory (LSTM) may be applied.

The controller 904A of the ADF 51A causes a CPU to execute a program stored in the ROM, thereby implementing the operation control unit 1821, the acquiring unit 1822, the calculating unit 1823, and the determination unit 2321.

The determination unit 2321 uses the trained model 2311 stored in the device controller 901A, so as to determine whether to execute skipping of abnormality determination.

Specifically, the determination unit 2321 outputs the sound data acquired by the acquiring unit 1822 to the device controller 901A, thereby receiving a determination result as to whether to execute skipping of abnormality determination from the device controller 901A.

The multifunction peripheral 100A according to the present embodiment performs the conveyance processing similarly to the processing procedure illustrated in FIG. 9, but the setting of the skip execution flag of the conveyance abnormality determination in step S1902 is different. Then, setting of the skip execution flag of the conveyance abnormality determination in the multifunction peripheral 100A according to the present embodiment will be described.

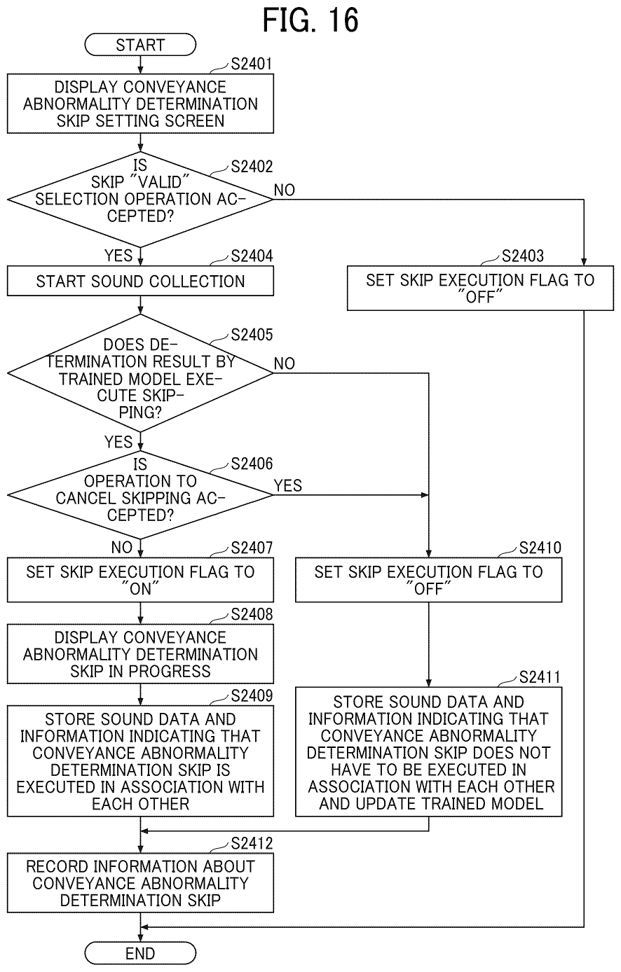

FIG. 16 is a flowchart exemplifying a procedure of setting processing of a skip execution flag of conveyance abnormality determination in the device controller 901A of the image forming device 1 and the controller 904A of the ADF 51A according to the third embodiment.

The display control unit 1802 displays a conveyance abnormality determination skip setting screen as illustrated in FIG. 11 at the start of setting the skip execution flag of the conveyance abnormality determination (step S2401).

The operation receiving unit 1801 determines whether a selection operation of skipping “VALID” is accepted on the conveyance abnormality determination skip setting screen (step S2402). When the operation receiving unit 1801 has accepted the selection operation, the device controller 901A notifies the controller 904A of a result of whether the function of skipping the conveyance abnormality determination is enabled.

When the operation receiving unit 1801 has accepted the pressing of the “INVALID” button 2102, in other words, when it is determined that the selection operation of skip “VALID” has not been accepted (NO in step S2402), “OFF” is set as the skip execution flag of the conveyance abnormality determination (step S2403), and the processing is ended.

On the other hand, when the operation receiving unit 1801 has accepted the pressing of the “VALID” button 2101, in other words, it is determined that the selection operation of skip “VALID” has been accepted (YES in step S2402), the acquiring unit 1822 starts acquiring sound data indicating the surrounding sound collected by the sound collecting microphone 205 (step S2404).

The determination unit 1824 outputs the sound data to the device controller 901A, and receives the determination result by the trained model 2311 from the device controller 901A. Then, the determination unit 2321 determines whether the received determination result indicates execution of skipping of the conveyance abnormality determination (step S2405).

When the determination unit 2321 determines that the skipping of the conveyance abnormality determination is not executed (NO in step S2405), “OFF” is set to the skip execution flag of the conveyance abnormality determination (step S2410).

Then, the controller 904A outputs information indicating that the conveyance abnormality determination is not skipped to the device controller 901A.

Then, the device controller 901A associates the sound data acquired in step S2404 and the information indicating that skipping of the conveyance abnormality determination is not executed and stores the associated data in the data accumulation unit 2312, and the training unit 2302 uses information stored in the data accumulation unit 2312, performs additional learning of the trained model 2311, and updates the trained model 2311 (step S2411).

On the other hand, when the determination unit 2321 determines that the skipping of the conveyance abnormality determination is executed (YES in step S2405), the display control unit 1802 of the device controller 901A displays a pop-up screen indicating whether the skipping of the conveyance abnormality determination may be executed.

Then, the determination unit 2321 determines whether the operation receiving unit 1801 has accepted an operation to cancel skipping (step S2406). When the determination unit 2321 determines that the operation to cancel skipping has been accepted (YES in step S2406), the processing of step S2410 and step S2411 is performed.

On the other hand, when the determination unit 2321 determines that the operation receiving unit 1801 has not accepted the operation to cancel skipping (YES in step S2406), “ON” is set as the skip execution flag of the conveyance abnormality determination (step S2407). Then, the controller 904A outputs information indicating that the conveyance abnormality determination is skipped to the device controller 901A.

Then, the display control unit 1802 of the device controller 901A displays that the conveyance abnormality determination is being skipped on the display 920 according to the information received from the controller 904A (step S2408).

Then, the device controller 901A stores the sound data acquired in step S2404 and the information indicating that the skipping of the conveyance abnormality determination is executed in the data accumulation unit 2312 in association with each other (step S2409).

After the processing of step S2009 or step S2011, the recording unit 1803 records information related to skipping of the conveyance abnormality determination based on the determination result by the determination unit 2321 in the log storage 1811 (step S2412). For example, the recording unit 1803 records information indicating the skip execution state together with the current date and time in the log storage 1811.

### Fourth Embodiment

In the third embodiment, an example of determining whether to skip the conveyance abnormality determination (process) using the trained model 2311 stored in the multifunction peripheral 100 has been described. However, the present invention is not limited to the mode in which the trained model 2311 is stored in the multifunction peripheral 100 as in the third embodiment. In a fourth embodiment, an example in which a server includes a trained model 2311 will be described.

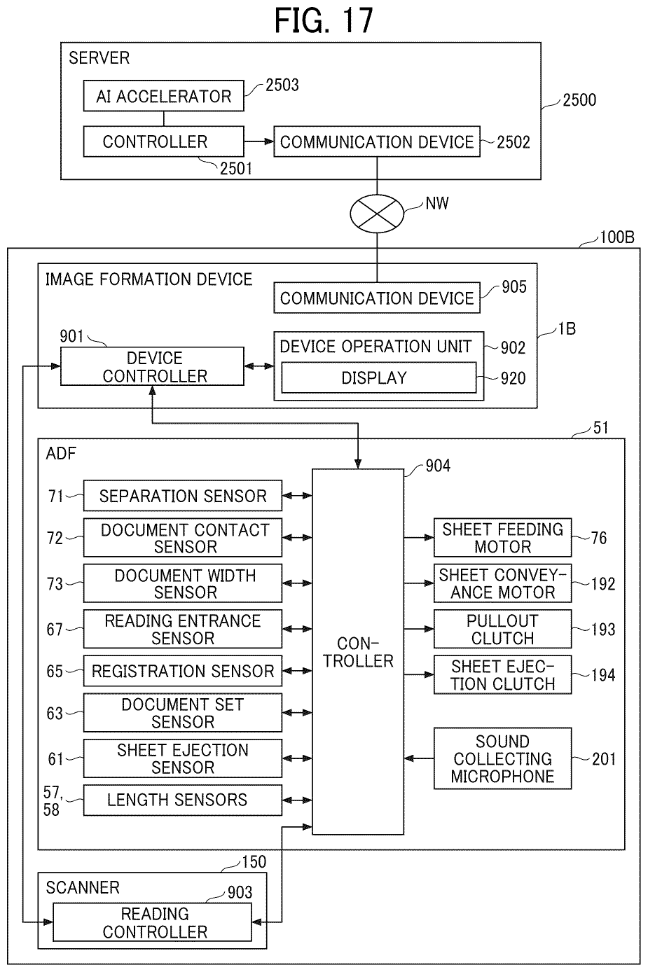

FIG. 17 is a block diagram illustrating a part of an electric circuit of the multifunction peripheral and the server according to the present embodiment.

The multifunction peripheral 100B according to the present embodiment is different in that the multifunction peripheral 100B includes a communication device 905 in the image forming device 1B.

A multifunction peripheral 100B illustrated in FIG. 17 includes an image forming device 1B, an ADF 51, and a scanner 150. The image forming device 1B according to the present embodiment includes a device controller 901, a device operation unit 902, and a communication device 905 as in the above-described embodiment.

A server 2500 according to the present embodiment includes a controller 2501, a communication device 2502, and an AI accelerator 2503.

Then, the communication device 905 of the image forming device 1B and the communication device 2902 of the server 2500 are communicably coupled via a communication network NW. The communication network NW may be a public communication line or a dedicated communication line.

When detecting that a document is set on the ADF 51, the device controller 901 of the image forming device 1B receives sound data from the ADF 51 as in the above-described embodiment.

Then, the communication device 905 transmits the received sound data to the server 2500 via the communication device 905. The sound data to be transmitted also includes sound data buffered for several seconds.

Then, the communication device 905 receives, from the server 2500, information indicating a determination result as to whether to execute skipping of the conveyance abnormality determination. Further, when receiving the information indicating the determination result indicating that the conveyance abnormality determination is skipped, the communication device 905 receives information in which the date and time when the sound was collected as the sound data is recorded from the server 2500.

Then, the device controller 901 outputs the received information to the controller 904. Then, the controller performs control based on the input information. The control to be performed is similar to that in the above-described embodiment, and the description thereof will be omitted.

The communication device 2502 of the server 2500 receives the sound data from the multifunction peripheral 100B.

The controller 2501 of the server 2500 uses the AI accelerator 2503 to generate information indicating a determination result as to whether to execute skipping of the conveyance abnormality determination from the sound data.

The controller 2501 stores the trained model 2311 of the above-described embodiment in the storage. The AI accelerator 2503 is provided with a library for utilizing the trained model. The AI accelerator 2503 according to the present embodiment can incorporate an inference unit corresponding to the trained model 2311 stored in the storage.

The controller 2501 can use the AI accelerator 2503 to receive information indicating the above-described determination result.

Then, the communication device 2502 of the server 2500 transmits the information generated in the controller 2501 to the multifunction peripheral 100B.

The conveyance abnormality determination system implemented by the multifunction peripheral 100 and the server 2500 according to the present embodiment automatically skips the conveyance abnormality determination according to the sound collected by the sound collecting microphone 205 and performs the pullout operation when the user sets the skipping function of the conveyance abnormality determination to be enabled in advance.

In the above-described embodiment and the modification, when noise is generated around the multifunction peripheral or when noise is generated in the multifunction peripheral, skipping the determination of conveyance abnormality can suppress erroneous detection of conveyance abnormality. Therefore, the multifunction peripheral according to the embodiment and the modification can suppress an operation stop or the like based on erroneous determination, and improve reliability of the conveyance operation.

### Fifth Embodiment

In addition, the configuration described in each of the above-described embodiments is not applied to an apparatus that conveys a document, and can also be applied to an apparatus that conveys a print medium. Thus, in the fifth embodiment, an example in which the present invention is applied to the manual sheet feeding device 300 of the multifunction peripheral 100 will be described.

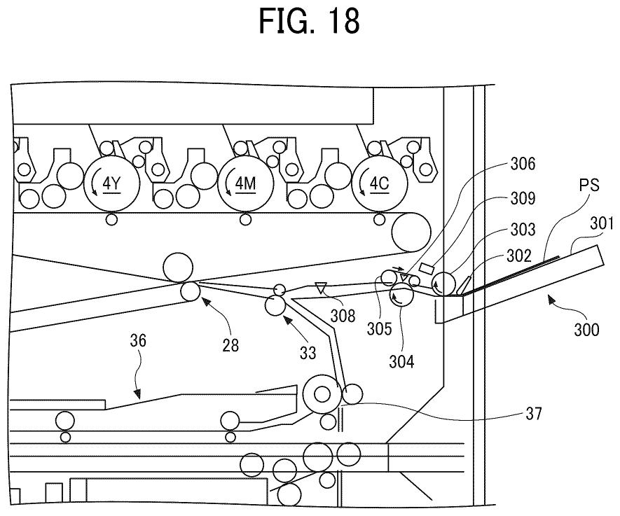

FIG. 18 is a partial configuration diagram illustrating a part of the periphery of the manual sheet feeding device 300 of the multifunction peripheral 100 according to the fifth embodiment.

FIG. 18 is a view of enlargement of the periphery of the manual sheet feeding device 300 provided in the multifunction peripheral 100 illustrated in FIG. 1.

As illustrated in FIG. 18, the manual sheet feeding device 300 includes a tray 301, a lever member 302, a pickup roller 303, a sheet separation roller 304, and a sheet feeding belt 305, and conveys a recording sheet PS which is an example of a conveyance medium.

The manual sheet feeding device 300 is provided with a sound collecting microphone 309 on the upstream side of the sheet separation roller 304. The sound collecting microphone 309 is disposed at a position where wrinkles and folds are estimated to occur so that the generated sound can be detected when wrinkles and folds occur while the transfer sheet set in the manual sheet feeding device 300 is conveyed.

For example, in the case where the recording sheet PS is set on the tray 301, the lever member 302 is pushed up. Accordingly, the controller 904 (see FIG. 7) receives a detection signal indicating that the setting of the recording sheets PS is detected. In a case where the controller 904 that has received the detection signal executes the image forming operation, when the recording sheet of the tray 301 is selected, the pickup roller 303 is rotationally driven. The recording sheet PS on the tray 301 is fed from the tray 301 by rotational driving of the pickup roller 303.

The recording sheet PS fed by the pickup roller 303 is separated into one sheet by the sheet separation roller 304 and the sheet feeding belt 305. The separation sensor 306 detects the leading end of the recording sheet PS separated into one sheet.

The recording sheet PS separated into one sheet enters the registration roller pair 33. Then, when the recording sheet PS passes immediately below the document contact sensor 308, the document contact sensor 308 detects the leading end of the recording sheet PS. After the leading end of the recording sheet PS is brought into contact with the registration nip region of the registration roller pair 33, the recording sheet PS is fed to the secondary transfer nip region.

The sound collecting microphone 309 is arranged on the upstream side of the separation mechanism configured by the sheet separation roller 304 and the sheet feeding belt 305, similarly to the above-described embodiment. The sound collecting microphone 309 can measure a measurement sound when a paper jam of the recording sheet PS occurs. In addition, in the case where the degree of adhesion between the uppermost recording sheet and the lower recording sheet is high due to humidity, static electricity, or the like, it is conceivable that the sound generated when the sheet passes through the sheet separation roller 304 and the sheet feeding belt 305 is larger than when the degree of adhesion is low. Thus, the controller 904 according to the present embodiment may measure sound generated when the sheet passes through the sheet separation roller 304 and the sheet feeding belt 305, and perform control in the same manner as in the above-described embodiment.

The determination unit 1824 of the controller 904 according to the present embodiment, when recognizing that the sound collecting microphone 309 has not performed sound collecting with a sound intensity level of a given level or higher level in a given period, sets the skip execution flag of the conveyance abnormality determination to “OFF” and starts determination as to whether abnormality has occurred in conveyance of the print medium by the conveyor. The given period is, for example, a period from when the print job and the fact that the sheet feeding position is the manual sheet feeding device 300 have been accepted to when the sheet feeding-and-separating operation is started. For example, when it is determined that the magnitude of the noise level detected in the given period is less than the given level, the determination unit 1824 does not skip the conveyance abnormality determination, so that the determination accuracy of the conveyance abnormality determination can be improved.

In addition, the given period for determining whether to skip the conveyance abnormality determination (process) is a period from when the print job and the sheet feeding position of the manual sheet feeding device 300 are accepted to when the sheet feeding-and-separating operation is started, in other words, a period while the multifunction peripheral 100 (as an image forming apparatus) provided with the manual sheet feeding device 300 is in operation.

In addition, the determination unit 1824 determines whether to execute skipping of the conveyance abnormality determination (including designation illustrated in FIG. 11) in consideration of the noise of the use environment based on the surrounding sound before sheet feeding, thereby improving the determination accuracy of the conveyance abnormality determination. Furthermore, in the multifunction peripheral 100, it is possible to reduce stress due to erroneous determination.

In addition, in the present embodiment, similarly to the above-described third embodiment, a trained model can be used for determining whether the collected sound satisfies a given condition. A specific application method is similar to the specific application method of the third embodiment, and the description thereof will be omitted.

The configurations according to the above-described embodiments are examples, and embodiments of the present disclosure are not limited to the above. For example, the following aspects can achieve effects described below.

### Aspect 1

In Aspect 1, a sheet conveying device includes a conveyance path, a conveyor, a sound collector, and circuitry. The conveyor conveys a medium along the conveyance path. The sound collector is disposed in a vicinity of the conveyor to collect a sound occurred in conveyance of the medium along the conveyance path by the conveyor. The circuitry is to determine whether an abnormal condition has occurred during the conveyance of the medium based on the sound collected by the sound collector to perform an abnormality determination process, and skip the abnormality determination process when the sound collected during a given period satisfies a given condition.

### Aspect 2

In Aspect 2, the sheet conveying device according to Aspect 1 further includes a detector and a separator. The detector detects a position of the medium conveyed by the conveyor. The separator conveys one medium of multiple media including the medium in the conveyance path. The circuitry is further to, after the detector detects that a leading end of the medium has passed through the separator, perform the abnormality determination process, or cause the sound collector to collect the sound to perform the abnormality determination process.

### Aspect 3

In Aspect 3, the sheet conveying device according to Aspect 1 further includes a detector and a contact portion. The detector detects a position of the medium conveyed by the conveyor. The contact portion contacts a leading end of the medium in the conveyance path. The circuitry is further to, until the detector detects that a leading end of the medium has reached the contact portion, perform the abnormality determination process, or cause the sound collector to collect the sound to perform the abnormality determination process.

### Aspect 4

In Aspect 4, in the sheet conveying device according to any one of Aspects 1 to 3, the circuitry is further to skip the abnormality determination process, and restart the abnormality determination process when the sound re-collected by the sound collector during the given period does not satisfy the given condition.

### Aspect 5

In Aspect 5, in the sheet conveying device according to any one of Aspects 1 to 4, the circuitry is further to switch whether to skip the abnormality determination process according to an operation accepted by an operation receiver.

### Aspect 6

In Aspect 6, an image forming apparatus includes a conveyance path, a conveyor, a sound collector, and circuitry. The conveyor conveys a medium along the conveyance path. The sound collector is disposed in a vicinity of the conveyor to collect a sound occurred in conveyance of the medium along the conveyance path by the conveyor. The circuitry is to determine whether an abnormal condition has occurred during the conveyance of the medium based on the sound collected by the sound collector to perform an abnormality determination process, and skip the abnormality determination process when the sound collected during a given period satisfies a given condition.

### Aspect 7

In Aspect 7, the image forming apparatus according to Aspect 6 further includes a display to display information indicating that the abnormality determination process is skipped when the abnormality determination process is skipped.

### Aspect 8

In Aspect 8, in the image forming apparatus according to Aspect 6, the circuitry is further to record information indicating that the abnormality determination process is skipped when the abnormality determination process is skipped.

### Aspect 9

In Aspect 9, in the image forming apparatus according to any one of Aspects 6 to 8, the sound collector collects the sound during the given period when the image forming apparatus is in operation.

### Aspect 10

In Aspect 10, in the image forming apparatus according to any one of Aspects 6 to 8, the sound collector collects the sound during the given period when the image forming apparatus is not in operation.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A sheet conveying device comprising:
a conveyance path;
a conveyor to convey a medium along the conveyance path;
a sound collector disposed in a vicinity of the conveyor to collect a sound occurred in conveyance of the medium along the conveyance path by the conveyor; and
circuitry configured to:
determine whether an abnormal condition has occurred during the conveyance of the medium based on the sound collected by the sound collector to perform an abnormality determination process; and
skip the abnormality determination process when the sound collected during a given period satisfies a given condition.

2. The sheet conveying device according to claim 1, further comprising:
a detector to detect a position of the medium conveyed by the conveyor; and
a separator to convey one medium of multiple media including the medium in the conveyance path,
wherein the circuitry is further configured to, after the detector detects that a leading end of the medium has passed through the separator:
perform the abnormality determination process, or
cause the sound collector to collect the sound to perform the abnormality determination process.

3. The sheet conveying device according to claim 1, further comprising:
a detector to detect a position of the medium conveyed by the conveyor; and
a contact portion to contact a leading end of the medium in the conveyance path,
wherein the circuitry is further configured to, until the detector detects that a leading end of the medium has reached the contact portion:
perform the abnormality determination process, or
cause the sound collector to collect the sound to perform the abnormality determination process.

4. The sheet conveying device according to claim 1,
wherein the circuitry is further configured to:
skip the abnormality determination process; and
restart the abnormality determination process when the sound re-collected by the sound collector during the given period does not satisfy the given condition.

5. The sheet conveying device according to claim 1,
wherein the circuitry is further configured to switch whether to skip the abnormality determination process according to an operation accepted by an operation receiver.

6. An image forming apparatus comprising:
a conveyance path;
a conveyor to convey a medium along the conveyance path;
a sound collector disposed in a vicinity of the conveyor to collect a sound occurred in conveyance of the medium along the conveyance path by the conveyor; and
circuitry configured to:
determine whether an abnormal condition has occurred during the conveyance of the medium based on the sound collected by the sound collector to perform an abnormality determination process; and
skip the abnormality determination process when the sound collected during a given period satisfies a given condition.

7. The image forming apparatus according to claim 6, further comprising:
a display to display information indicating that the abnormality determination process is skipped when the abnormality determination process is skipped.

8. The image forming apparatus according to claim 6,
wherein the circuitry is further configured to record information indicating that the abnormality determination process is skipped when the abnormality determination process is skipped.

9. The image forming apparatus according to claim 6,
wherein the sound collector collects the sound during the given period when the image forming apparatus is in operation.

10. The image forming apparatus according to claim 6,
wherein the sound collector collects the sound during the given period when the image forming apparatus is not in operation.
